(19) United States
(12) Patent Application Publication
(10) Pub. No.: US 2025/0238578 A1
(43) Pub. Date: Jul. 24, 2025

(54) GENERATION AND SIMULATION OF BUILDING DESIGNS FOR ENERGY AND COMFORT PERFORMANCE

(71) Applicant: AUTODESK, INC., San Francisco, CA (US)

(72) Inventors: Jihoon Chung, Berkeley, CA (US); James STODDART, Atlanta, GA (US); John Henry LOCKE, New York, NY (US); Rhys GOLDSTEIN, Toronto (CA); Nastaran SHAHMANSOURI, Toronto (CA)

(21) Appl. No.: 19/035,582

(22) Filed: Jan. 23, 2025

Related U.S. Application Data
(60) Provisional application No. 63/624,689, filed on Jan. 24, 2024.
(60) Provisional application No. 63/624,697, filed on Jan. 24, 2024.

(51) Int. Cl. G06F 30/20; G06F 30/13

(52) U.S. Cl. CPC G06F 30/20; G06F 30/13

(57) ABSTRACT

A design generation and simulation workflow for generating design layouts and executing simulations of the design layouts to generate energy and comfort performance metrics that indicate the energy efficiency and occupant-comfort levels associated with the design layouts. As described herein, the design workflow includes five phases including 1) configuring a design generation application, 2) generating design layouts via the design generation application, 3) generating energy models for the design layouts, 4) configuring simulations on the energy models, and 5) executing the configured simulations on the energy models and generating comparative results based on the simulation results of multiple simulations.

### CROSS-REFERENCE TO RELATED APPLICATIONS

This application claims priority benefit of the United States Provisional Patent Application titled, “AUTOMATED GENERATION AND ANALYSIS OF NATURAL VENTILATION PERFORMANCE USING TILE-BASED BUILDING GEOMETRY,” filed on Jan. 24, 2024, and having Ser. No. 63/624,689. The subject matter of this related application is hereby incorporated herein by reference. This application also claims priority benefit of the United States Provisional Patent Application titled, “AUTOMATED COMPARATIVE ANALYSIS OF ALTERNATIVE COMFORT AND OCCUPANCY MODELS IN BUILDING ENERGY ANALYSIS,” filed on Jan. 24, 2024, and having Ser. No. 63/624,697. The subject matter of this related application is also hereby incorporated herein by reference. This application is also related to the United States Patent Application titled, “TECHNIQUES FOR GENERATIVE DESIGN BASED ON LARGE LANGUAGE MODELS,” filed on Jun. 7, 2024, and having Ser. No. 18/737,859. The subject matter of this related application is also hereby incorporated herein by reference.

### BACKGROUND

### Field of the Various Embodiments

Embodiments of the present disclosure relate generally to computer-aided design, and, more specifically, to generation and simulation of building designs for energy and comfort performance.

### DESCRIPTION OF THE RELATED ART

The field of computer-aided design in architecture and engineering includes creating diverse designs that meet specified constraints. For example, computer-aided design has been implemented in the design and simulation of building design layouts for improving energy and comfort performance. In particular, the design and development of sustainable buildings that improve energy efficiency in providing thermal comfort for occupants inside the buildings (referred to as “climate conditioning”) has become increasingly important for reducing the overall energy usage of the building. Building design layouts are often designed assuming that an artificial ventilation system, such as a heating, ventilation, and air conditioning (HVAC) system, will be implemented in the building to provide the climate conditioning. However, building design layouts are increasingly being designed to include natural ventilation (NV) due to the possible reduction in energy usage of the buildings. Building design layouts that include natural ventilation rely on the external climate/environment to passively assist in providing climate conditioning inside of buildings, thereby potentially improving the energy efficiency of the buildings by a significant margin relative to using only an HVAC system. Building design layouts implementing a multi-mode (MM) system that uses both natural ventilation and an HVAC system for climate conditioning are also becoming increasing popular due to the potential improvements in energy efficiency.

For a particular building project, a large number of candidate building design layouts can be generated, where each candidate building design layout attempts to optimize energy efficiency for providing climate conditioning inside the building by using various climate conditioning strategies/modes, such as HVAC only, NV only, or MM. An energy model can be generated for each candidate design layout for performing one or more energy-analysis simulations. An energy-analysis simulation can be executed on each energy model that corresponds to a design layout to generate simulation results, such as energy and comfort performance metrics. The energy performance metrics can indicate the energy efficiency of the corresponding design layout, while the comfort performance metrics can indicate occupant-comfort levels achieved by the corresponding design layout. In addition, for each energy model of a design layout, multiple simulations can be configured and executed based on a variety of simulation input parameters, such as the building location, climate-conditioning mode (HVAC only, NV only, or MM), an occupancy model, and a comfort model.

One drawback of conventional approaches for performing energy-analysis simulations is that generating the energy model for a design layout is a difficult and error-prone manual process. In particular, a user typically generates the energy model corresponding to the design layout by manually determining and tagging/labeling portions of the energy model with energy properties based on both the design layout and the user's expertise in computer-aided design and thermal properties of surface materials. Manually tagging/labeling portions of the energy model with energy properties is a difficult process that requires extensive expertise to be performed properly, and often results in an energy model having energy properties that do not correctly represent the energy properties of the corresponding design layout. Thus, when the incorrect energy model is executed, the energy-analysis simulation will return simulation results that do not accurately represent the energy properties of the corresponding design layout, which can it make it difficult for the user to make well-informed design decisions.

Another drawback of conventional approaches for performing energy-analysis simulations is that the conventional occupancy and comfort models implemented in the energy-analysis simulations are outdated and/or inaccurate. For example, a conventional occupancy model specifies a predicted occupancy level of the building during one or more hours of the day based on typical pre-COVID occupancy behaviors/patterns. However, the conventional occupancy model does not consider changes to occupancy behaviors/patterns that have occurred post-COVID, which are significantly different. As another example, a conventional comfort model specifies a comfort range that is acceptable to occupants in a building based on a “standard” occupant. However, the conventional comfort model does not consider specific demographic-based factors of the expected occupants, such as culture or gender, and is only based on a generic “standard” occupant. When configured with inaccurate occupancy models and/or comfort models, the energy-analysis simulation will likewise return inaccurate simulation results for the corresponding design layout, which does not allow the user to make well-informed design decisions.

A further drawback of conventional approaches for performing energy-analysis simulations is that executing multiple different simulations yields separate simulation results for each simulation, which makes comparison of the simulation results between the different simulations difficult for the user. For example, multiple simulations can be executed on multiple different energy models corresponding to multiple different design layouts using the same simulation configuration, which yields multiple simulation results. As another example, multiple simulations can be executed on a same energy model that corresponds to a same design layout using the multiple different simulation configurations, which also yields in multiple simulation results. In either case, conventional simulation applications will not generate or provide any comparative analysis and results based on the separate simulation results of multiple different simulations. As such, conventional simulation applications do not provide the user with meaningful insight into the different energy and comfort characteristics of different design layouts and/or different simulation configurations. As a result, the user will not be well-informed in regards to the energy and comfort performance differences when making design decisions for the building project.

As the foregoing indicates, what is needed in the art are more effective techniques for the generation and simulation of building designs for energy and comfort performance.

### SUMMARY

Various embodiments of the present disclosure set forth a computer-implemented method for performing an energy-analysis simulation. The computer-implemented method includes generating a design layout of a building, the design layout including embedded metadata specifying a set of energy properties associated with the design layout, generating an energy model for the design layout based on the embedded metadata of the design layout, executing the energy-analysis simulation on the energy model to generate a set of simulation results, and displaying the set of simulation results.

One technical advantage of the disclosed techniques relative to the prior art is that an accurate energy model can be generated for a design layout in an automated manner. The design layout of a building is generated as a set of tiles, whereby each tile comprises a sub-portion of the design layout and represents a sub-portion of the building. Each tile includes embedded metadata that specifies one or more energy properties associated with the tile. The energy model can be generated from the design layout by automatically extracting the embedded metadata from the set of tiles of the design layout and tagging/labeling corresponding sub-portions of the energy model with the extracted metadata. In this manner, the disclosed techniques can automatically generate an accurate energy model that correctly represents the energy properties of the corresponding design layout. Thus, when the energy model is executed by a simulation application, the simulation application provides simulation results that accurately represent the energy properties of the corresponding design layout, which enable users to make well-informed design decisions. As such, the disclosed techniques avoid the error-prone manual tagging/labeling process of prior techniques that often resulted in an energy model and simulation results that do not correctly represent the energy properties of the corresponding design layout. These technical advantages provide one or more technological improvements over prior art approaches.

Various embodiments of the present disclosure set forth a computer-implemented method for performing an energy-analysis simulation. The computer-implemented method includes determining a first energy model that represents a first design layout for a building, determining a first comfort model specifying a first comfort range based on a first demographic group associated with the building, causing a first energy-analysis simulation to be executed on the first energy model based on the first comfort model to generate a first set of simulation results, and displaying the first set of simulation results.

One technical advantage of the disclosed techniques relative to the prior art is that the disclosed techniques implement updated and accurate occupancy and comfort models when performing energy-analysis simulations. In some embodiments, an occupant demographic-based comfort model specifies a comfort range predicted to be acceptable to occupants of a particular demographic group that is based on culture, gender, income level, and the like. In some embodiments, an updated occupancy model can specify a predicted occupancy level based on post-COVID occupancy behaviors/patterns. In this manner, the disclosed techniques implement updated and more accurate occupancy and comfort models when performing energy-analysis simulations relative to prior approaches. As a result, more accurate simulation results (such as energy and comfort performance metrics) are provided for the corresponding design layout relative to prior approaches, which can enable users to make well-informed design decisions. Another technical advantage of the disclosed techniques relative to the prior art is that the disclosed techniques generate and display comparative results that provide comparisons between simulation results from at least two different simulations. In this manner, the disclosed techniques provide meaningful insight into the different energy and comfort characteristics of different design layouts and/or different simulation configurations for a same design layout that is not provided in prior approaches. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of the various embodiments;

FIG. 2 illustrates a block diagram of a computer-based system according to various embodiments;

FIG. 3 illustrates an example set of design examples received by the design generation application, according to various embodiments;

FIG. 4 illustrates an example set of design layouts generated by the design generation application, according to various embodiments;

FIG. 5 shows a conceptual illustration of a design-layout table associated with a design layout, according to various embodiments;

FIG. 6 illustrates an example design layout selected for an energy-analysis simulation, according to various embodiments;

FIG. 7 illustrates an energy model generated for the example design layout of FIG. 6, according to various embodiments;

FIG. 8 shows a conceptual illustration of an occupancy model based on pre-COVID occupancy behaviors of a residential building, according to various embodiments;

FIG. 9 shows a conceptual illustration of an occupancy model based on during-COVID or post-COVID occupancy behaviors of a residential building, according to various embodiments;

FIG. 10 illustrates a configuration interface of the design workflow application for configuring multiple simulations, according to various embodiments;

FIG. 11 illustrates a simulation-results interface of the design workflow application for displaying simulation results of multiple simulations, according to various embodiments;

FIG. 12 illustrates a comparative-results interface of the design workflow application for displaying comparative results for multiple simulations, according to various embodiments;

FIG. 13 illustrates a comparative-graph interface of the design workflow application for displaying energy-based comparative results, according to various embodiments;

FIG. 14 illustrates a comparative-graph interface of the design workflow application for displaying comfort-based comparative results, according to various embodiments;

FIG. 15 illustrates a design-comparison interface of the design workflow application for displaying design-based comparative results, according to various embodiments; and

FIG. 16 sets forth a flow diagram of method steps for a design generation and simulation workflow, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

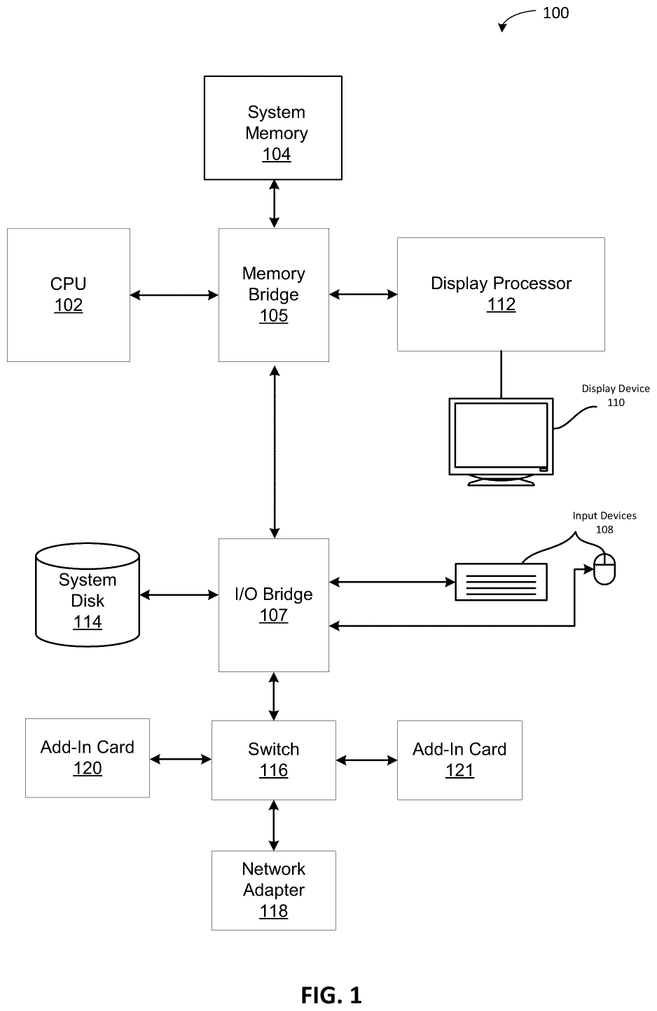

FIG. 1 illustrates a computer system 100 configured to implement one or more aspects of the various embodiments. FIG. 1 in no way limits or is intended to limit the scope of the present disclosure. In various implementations, computer system 100 can be an augmented reality, virtual reality, or mixed reality system or device, a personal computer, video game console, personal digital assistant, mobile phone, mobile device or any other device suitable for practicing one or more embodiments of the disclosed techniques. Further, in various embodiments, any combination of two or more computer systems 100 can be coupled together to practice one or more aspects of the disclosed techniques.

As shown, computer system 100 includes a central processing unit (CPU) 102 and a system memory 104 communicating via a bus path that may include a memory bridge 105. CPU 102 includes one or more processing cores, and, in operation, CPU 102 is the master processor of computer system 100, controlling and coordinating operations of other system components. System memory 104 stores software applications and data for use by CPU 102. CPU 102 runs software applications and optionally an operating system. Memory bridge 105, which can be, e.g., a Northbridge chip, is connected via a bus or other communication path (e.g., a HyperTransport link) to an I/O (input/output) bridge 107. I/O bridge 107, which may be, e.g., a Southbridge chip, receives user input from one or more user input devices 108 (e.g., keyboard, mouse, joystick, digitizer tablets, touch pads, touch screens, still or video cameras, motion sensors, and/or microphones) and forwards the input to CPU 102 via memory bridge 105.

A display processor 112 is coupled to memory bridge 105 via a bus or other communication path (e.g., a PCI Express, Accelerated Graphics Port, or HyperTransport link); in one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104.

Display processor 112 periodically delivers pixels to a display device 110 (e.g., a screen or conventional CRT, plasma, OLED, SED or LCD based monitor or television). Additionally, display processor 112 can output pixels to film recorders adapted to reproduce computer generated images on photographic film. Display processor 112 can provide display device 110 with an analog or digital signal. In various embodiments, one or more of the various graphical user interfaces are displayed to one or more users via display device 110, and the one or more users can input data into and receive visual output from those various graphical user interfaces.

A system disk 114 is also connected to I/O bridge 107 and can be configured to store content and applications and data for use by CPU 102 and display processor 112. System disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O bridge 107 and other components such as a network adapter 118 and various add-in cards 120 and 121. Network adapter 118 allows computer system 100 to communicate with other systems via an electronic communications network, and can include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 incorporates circuitry optimized for graphics and video processing, including, for example, video output circuitry, and constitutes a graphics processing unit (GPU). In another embodiment, display processor 112 incorporates circuitry optimized for general purpose processing. In yet another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments, instructions and/or data representing a scene are provided to a render farm or a set of server computers, each similar to computer system 100, via network adapter 118 or system disk 114. The render farm generates one or more rendered images of the scene using the provided instructions and/or data. These rendered images may be stored on computer-readable media in a digital format and optionally returned to computer system 100 for display. Similarly, stereo image pairs processed by display processor 112 may be output to other systems for display, stored in system disk 114, or stored on computer-readable media in a digital format.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or graphics memory within display processor 112. In an embodiment, display processor 112 includes three-dimensional (3D) rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

Further, in other embodiments, CPU 102 or display processor 112 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 102, display processor 112, or one or more other processing devices or any combination of these different processors.

CPU 102, render farm, and/or display processor 112 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, computer system 100 may be a robot or robotic device and may include CPU 102 and/or other processing units or devices and system memory 104. In such embodiments, computer system 100 may or may not include other elements shown in FIG. 1. System memory 104 and/or other memory units or devices in computer system 100 may include instructions that, when executed, cause the robot or robotic device represented by computer system 100 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies display processor 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

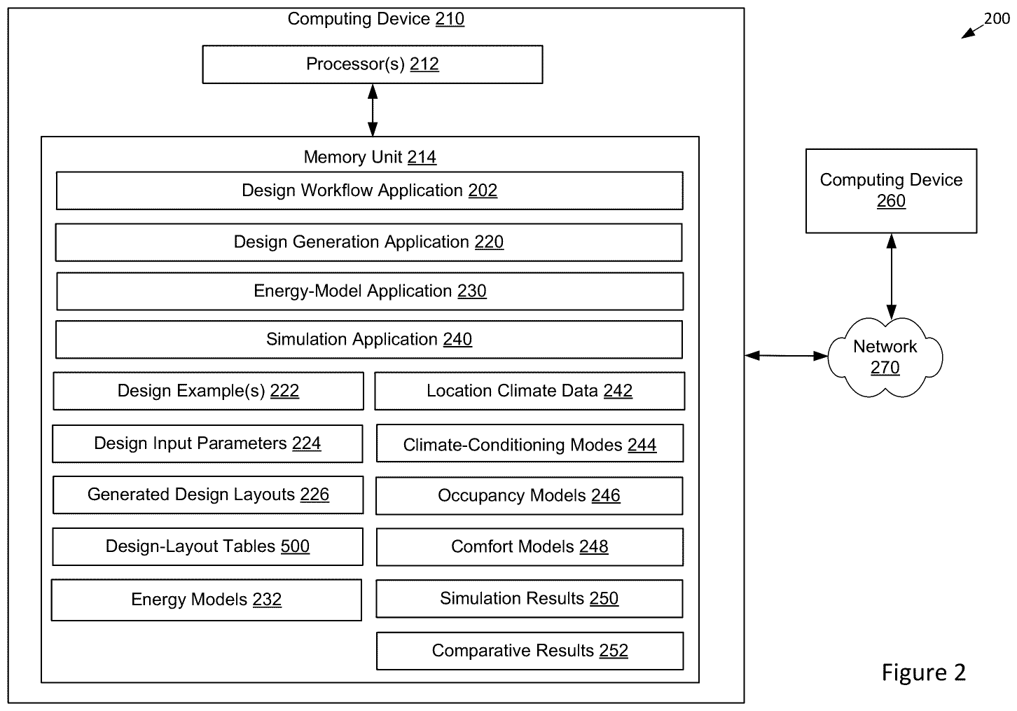

FIG. 2 illustrates a block diagram of a computer-based system 200 according to various embodiments. As shown, computer-based system 200 includes, without limitation, computing devices 210 and 260 and a network 270. Computing device 210 includes, without limitation, one or more processors 212 and memory 214. Memory 214 includes various software applications for executing the various techniques described herein including, without limitation, a design workflow application 202, a design generation application 220, an energy-model application 230, and a simulation application 240. Memory 214 further includes various data for executing the various techniques described herein including, without limitation, design layout examples 222 (referred to herein as design examples 222), design input parameters 224, generated design layouts 226, design-layout tables 500, energy models 232, location climate data 242, climate-conditioning modes 244, occupancy models 246, comfort models 248, simulation results 250, and comparative results 252.

Computing device 210 shown herein is for illustrative purposes only, and variations and modifications in the design and arrangement of computing device 210, without departing from the scope of the present disclosure. In some examples, computing device 210 includes an architecture consistent with the architecture of computer system 100. For example, the number of processors 212, the number of and/or type of memories 214, and/or the number of applications and or data stored in memory 214 can be modified as desired. In some embodiments, any combination of processor(s) 212 and/or memory 214 can be included in and/or replaced with any type of virtual computing system, distributed computing system, and/or cloud computing environment, such as a public, private, or a hybrid cloud system.

Each of processor(s) 212 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 212 can be any technically feasible hardware unit capable of processing data and/or executing software applications. During operation, processor(s) 212 can receive user input from input devices (not shown), such as a keyboard or a mouse.

Memory 214 of computing device 210 stores content, such as software applications and data, for use by processor(s) 212. Memory 214 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 214. The storage can include any number and type of external memories that are accessible to processor(s) 212. For example, and without limitation, the storage can include a Secure Digital Card, an external Flash memory, a portable CD-ROM, an optical storage device, a magnetic storage device, and/or any suitable combination of the foregoing.

Network 270 can be a wide area network (WAN), such as the Internet, a local area network (LAN), a cellular network, and/or any other suitable network. Computing devices 210 and 260 are in communication over network 270. For example, network 270 can include any technically feasible network hardware suitable for allowing two or more computing devices to communicate with each other. Computing device 260 shown herein is for illustrative purposes only, and variations and modifications in the design and arrangement of computing device 260, without departing from the scope of the present disclosure. In some examples, computing device 260 includes an architecture consistent with the architecture of computer system 100. In some embodiments, computing device 210 communicates with computing device 260 to provide the design workflow processes described herein as a cloud-based service to computing device 260 via the network 270.

The computing device 210 executes the design workflow application 202 which controls/coordinates the initiation and execution of the design generation application 220, the energy-model application 230, and the simulation application 240 to perform a design generation and simulation workflow (referred to herein as the “design workflow”) described herein for generating design layouts 226 and executing simulations of the design layouts 226 to generate simulation results and comparative results. The design workflow application 202 also generates various user interfaces for performing the design workflow. The simulation results can include energy and/or comfort performance metrics that indicate the energy efficiency and occupant-comfort levels associated with the design layouts 226.

As described herein, the design workflow includes five phases/stages including 1) configuring the design generation application 220, 2) generating design layouts 226 via the design generation application 220, 3) generating energy models 232 for the design layouts 226, 4) configuring simulations on the energy models 232, and 5) executing the configured simulations on the energy models 232 and generating comparative results 252 based on the simulation results 250 of multiple simulations. The design workflow application 202 generates a user interface for receiving any various inputs, such as the design input parameters 224 and the simulation input parameters, and for displaying any various outputs, such as the generated design layouts 226, energy models 232, simulation results 250, and comparative results 252 that are used during the design workflow process.

The first phase for configuring the design generation application 220 includes receiving design input parameters 224 and one or more design examples 222 from a user via a user interface. The design generation application 220 then inputs the design input parameters 224 and one or more design examples 222 into the design generation application 220. The design input parameters 224 specify design constraints and/or design objectives for generating building design layouts 226 for a particular building project. The one or more design examples 222 are analyzed by the design generation application 220 to generate additional design layouts 226. The second phase for generating design layouts 226 includes the design workflow application 202 causing/initiating the design generation application 220 to generate one or more design layouts 226 based on the design input parameters 224 and the one or more example designs 222. In some embodiments, each generated design layout 226 is a tile-based design layout comprising a set of tiles that include embedded energy metadata specifying energy-based properties associated with each tile. In these embodiments, each design layout 226 comprises a set of tiles, each tile included in the set of tiles having embedded metadata specifying at least one energy property associated with the tile.

The third phase for generating energy models 232 includes the design workflow application 202 causing/initiating the energy-model application 230 to automatically generate an energy model 232 for each generated design layout 226. Generating an energy model 232 for a corresponding design layout 226 includes extracting the energy properties embedded in the set of tiles of the design layout 226 and labeling the energy model 232 with the extracted energy properties. Each energy model 232 is in a simulation-compliant format that is executable by a simulation application 240.

The fourth phase for configuring the simulations on the energy models 232 can include configuring multiple different simulations for multiple different energy models 232 and/or configuring multiple different simulations for a same energy model 232 with different simulation configurations via the design workflow application 202. For each separate simulation, the design workflow application 202 receives a selected energy model 232 and a selected set of simulation input parameters that specify the simulation configuration of the selected energy model 232 from a user via the user interface. The set of simulation input parameters can include, without limitation, the location climate data 242, the climate-conditioning mode 244, an occupancy model 246, and/or a comfort model 248. The location climate data 242 can include climate data associated with the building location. The climate-conditioning mode 244 can include, for example, an HVAC only mode, NV only mode, or MM mode. The occupancy model 246 can include, for example, a first occupancy model based on pre-COVID occupancy behaviors/patterns or a second occupancy model based on post-COVID occupancy behaviors/patterns. The comfort model 248 can include, for example, a standardized comfort model or an occupant demographic-based comfort model. The occupant demographic-based comfort model can specify a comfort range predicted to be acceptable to occupants of a specific demographic group that is based, for example, on culture, gender, income level, and the like. For example, the demographic group can be based on at least one of culture information, gender information, or income level information.

The fifth phase for executing the configured simulations and generating comparative results includes the design workflow application 202 loading the configured simulations to the simulation application 240 and causing/initiating the simulation application 240 to execute each configured simulation for generating separate simulation results 250 (such as energy and comfort performance metrics) for each configured simulation. The fifth phase further includes the design workflow application 202 generating comparative results 252 based on an analysis and comparison of the simulation results 250 of two or more different simulations. The design workflow application 202 also displays the separate simulation results 250 and comparative results 252 in the fifth phase via the user interface.

### First and Second Phases: Configuring the Design Generation Application and Generating Design Layouts

The first phase for configuring the design generation application 220 includes the design generation application 220 receiving design input parameters 224 and one or more design examples 222. The design generation application 220 generates a user interface for receiving user inputs and for displaying the one or more design examples 222, the design input parameters 224, and the one or more generated design layouts 226. The design input parameters 224 can specify geometric design constraints and/or design objectives for generating building design layouts 226 for a desired building of a particular architectural building project. For example, the desired building can be a residential building or non-residential workplace building, such as an office building or manufacturing building. For example, the design input parameters 224 can include, but are not limited to, specific requirements for an architectural design, such as maximum size dimensions of the building, a maximum envelope (length, width, height), maximum building site footprint, desired number of floors, desired number of residential units, green space requirements, zoning laws, building height restrictions, environmental impact considerations, material specifications, manufacturing constraints, ergonomic requirements, and/or the like for the architectural building project.

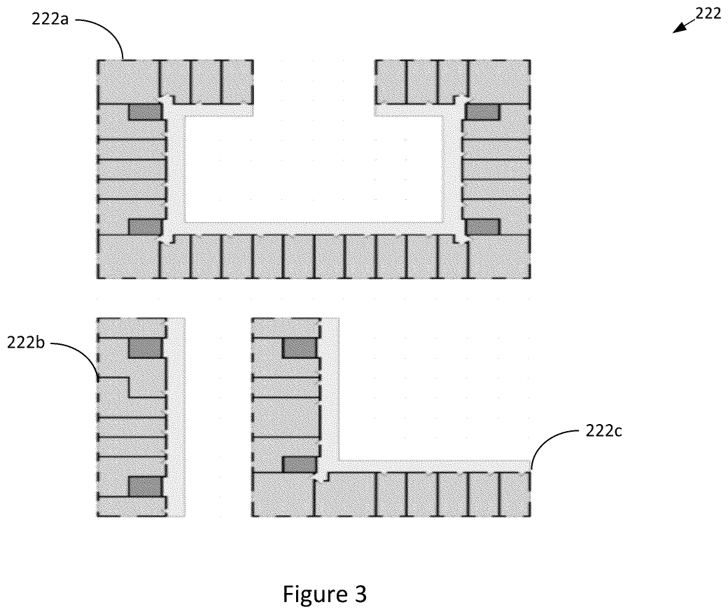

The first phase also includes the user selecting and entering one or more design examples 222 for analysis by the design generation application 220. Design examples 222 are pre-existing design layouts that serve as references or templates for generating new design layouts 226 and inferring design constraints. Design examples 222 can include successful architectural plans, common building configurations, innovative design solutions, and/or the like. FIG. 3 illustrates an example set of design examples 222 received by the design generation application 220, according to various embodiments. As shown, the set of design examples 222 include a first design example 222a, a second design example 222b, and a third design example 222c. In some embodiments, each design example 222 comprises a tile-based design layout of an example building that illustrates to the design generation application 220 which types of tiles can be used and examples of how the tiles can fit together to collectively form a design layout.

The second phase for generating design layouts 226 includes the design workflow application 202 causing/initiating the design generation application 220 to generate one or more generated design layouts 226 based on the design input parameters 224 and the one or more design examples 222. Each generated design layout 226 can comprise 3D geometry of the building, such as a 3D model of the building. In some embodiments, each generated design layout 226 is a tile-based design layout comprising a set of tiles. Each tile included in the set of files comprises a sub-portion of the design layout and represents a sub-portion of the building. The specific configuration and/or arrangement of the set of tiles comprises the design layout 226.

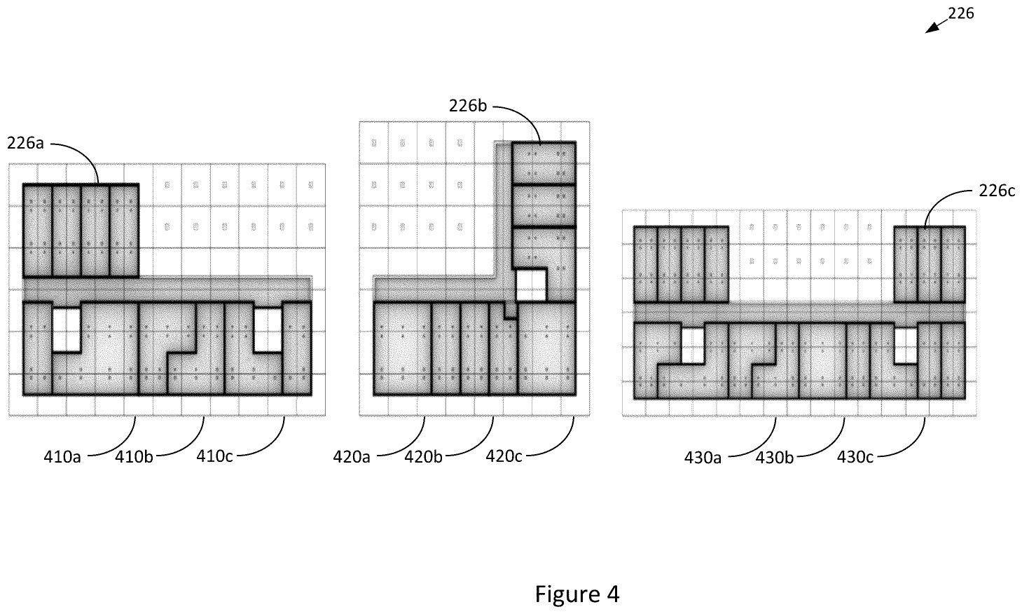

FIG. 4 illustrates an example set of design layouts 226 generated by the design generation application 220, according to various embodiments. As shown, the set of design layouts 226 include a first design layout 226a, a second design layout 226b, and a third design layout 226c. In some embodiments, each design layout 226 comprises a tile-based design layout of the desired building, wherein each design layout 226 comprises a set of tiles. As shown, each design layout 226 is represented as a grid composed of a set of tiles. For example, the first design layout 226a includes a first set of tiles 410 (that include for example, tiles 410a, 410b, 410c), the second design layout 226b includes a second set of tiles 420 (that include for example, tiles 420a, 420b, 420c), and the third design layout 226c includes a third set of tiles 430 (that include for example, tiles 430a, 430b, 430c). Notably, each design layout 226 can represent a layout of a single floor of the building, whereby the single floor can be stacked to generate multiple floors of the building to generate a 3D model of the building. In other embodiments, the design generation application 220 generates a different number of design layouts 226 than shown in the example of FIG. 4.

The design generation application 220 can generate the design layouts 226 by varying a plurality of layout factors to improve the energy efficiency and natural ventilation performance of the building. The plurality of layout factors that can be varied include the number, locations, and dimensions of architectural/geometric elements including different building surfaces such as doors, windows, walls, and roof of the building. The plurality of layout factors that can be varied also include the construction materials for the different building surfaces, such as the doors, windows, walls, and roof. In addition, for each generated design layout 226, the design generation application 220 can generate multiple versions of the design layout 226 by associating different building orientations to the design layout 226.

The techniques implemented by the design generation application 220 for generating the tile-based design layouts 226 based on the design input parameters 224 and the design examples 222 are described in detail in United States Patent Application titled, “TECHNIQUES FOR GENERATIVE DESIGN BASED ON LARGE LANGUAGE MODELS,” filed on Jun. 7, 2024, and having Ser. No. 18/737,859. The subject matter of this application is incorporated herein by reference. In summary, the design generation application 220 extracts from the design examples 222 a set of rules used to generate design layouts that are similar to the design examples 222. The design generation application 220 can implement the Wave Function Collapse (WFC) algorithm to generate a diverse set of floorplan layouts for a desired building. The design examples 222 indicate reference building configurations that can be used to train a WFC model. The Wave Function Collapse (WFC) algorithm enables a geometry-generation model to synthesize constrained design variations using a set of input design examples to automatically generate similar building tile-based geometries comprising diverse variations of building design layouts. The WFC algorithm can combine different types of tiles representing different building surfaces based on the set of rules learned from the provided input design examples 222.

Each generated design layout 226 is a tile-based design layout comprising a set of tiles. Each tile included in the set of files comprises a sub-portion of the design layout and includes one or more architectural/geometric elements. Each architectural/geometric element represents a particular type of building surface from a plurality of different surface types, such as a door, window, wall, floor, or roof of the building. In some embodiments, the plurality of different surface types also include more specific surface types, such as an interior wall, an air wall, a ceiling, an exterior floor, an interior floor, an aperture, an interior aperture, an interior door, an outdoor shade, an indoor shade, and the like.

In some embodiments, each generated design layout 226 comprises a set of tiles that include embedded energy metadata specifying energy-based properties associated with the set of tiles. In particular, each tile includes embedded metadata that specifies one or more energy properties associated with the one or more architectural/geometric elements within the tile. The energy properties associated with a particular geometric element can be based on the surface type of the particular geometric element. The different types of building surfaces can each have a different set of associated energy properties. For example, a window surface can have a first set of associated energy properties, a wall surface can have a second set of associated energy properties, a roof surface can have a third set of associated energy properties, and so forth.

In other embodiments, the energy properties associated with a particular geometric element can be based on the surface type of the particular geometric element and/or a construction type of the particular geometric element. A construction type of a geometric element can include the physical material composition of the geometric element, such as wood, glass, tile, metal, plastic, and the like. For example, a geometric element comprising a wall can have a construction type that is specified as a 2″×6″ wood-framed wall with exterior brick facing (such as 4″ face brick, 1.5″ air gap, 0.75″ plywood, 2″×6″ with R13 insulation, ½″ drywall), which can be linked to a description of each layer of the wall assembly that is used to compute the a single coefficient of thermal transmittance that the energy simulation uses to calculate energy flow. In some embodiments, the energy properties associated with a particular geometric element include specific values for a thermal property, a thermal coefficient, a thermal transference property, a coefficient of thermal transmittance, specific heat, reflectance, and/or any other type of thermal or energy characteristic of a building surface.

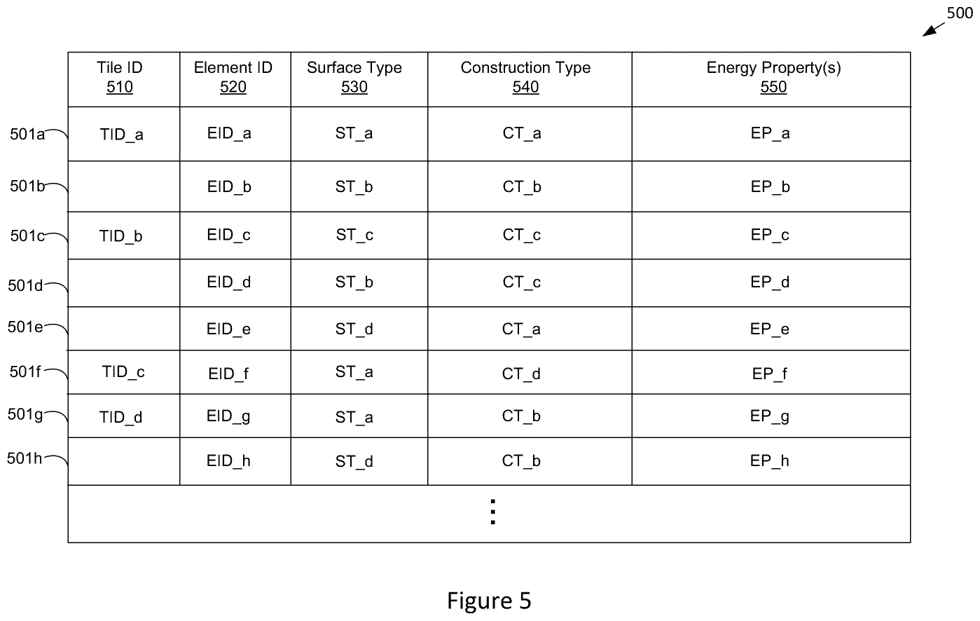

In some embodiments, the energy metadata for a design layout 226 is stored to a design-layout table 500 associated with the design layout 226. FIG. 5 shows a conceptual illustration of a design-layout table 500 associated with a design layout 226, according to various embodiments. The design-layout table 500 can store a set of energy properties for each geometric element included in the set of tiles of the corresponding design layout 226. The design-layout table 500 can be any type of data container or data structure for storing and organizing the energy properties associated with the corresponding design layout 226, for example, by organizing the energy properties based on the geometric elements and the set of tiles of the corresponding design layout 226. In other embodiments, the design-layout table 500 is only conceptual in nature only and serves to illustrate that associated energy properties are linked to the geometric elements and tiles of the corresponding design layout 226 in some manner.

As shown, the design-layout table 500 can include a plurality of element entries 501 (such as 501a, 501b, 501c, etc.), each element entry 501 representing a particular geometric element included in the corresponding design layout 226. The design-layout table 500 can store a set of energy properties for each geometric element included in the corresponding design layout 226. Each element entry 501 for a geometric element comprises a plurality of data fields including, without limitation, a tile identifier (tile ID) 510, geometric-element identifier (element ID) 520, surface type 530, construction type 540, and a set of energy properties 550. The geometric element is included in a particular tile in the design layout 226, the tile being uniquely identified in the design layout 226 by the tile ID 510. The element ID 520 for the geometric element can comprise a unique Identifying ID (UUID) that uniquely identifies the geometric element in the design layout 226. The surface type 530 specifies the surface type of the geometric element, such as a door, window, wall, or roof of the building. The construction type 540 specifies the construction type of the geometric element. The set of energy properties 550 includes specific values for one or more energy properties of the geometric element.

In some embodiments, the design generation application 220 can automatically embed the energy metadata into each design layout 226 by automatically populating the design-layout table 500 associated with the design layout 226 with energy metadata. In these embodiments, the design generation application 220 can automatically determine the set of energy properties for a geometric element in a tile of a design layout 226 based on the surface type and/or construction type associated with the geometric element. For example, for each geometric element in a tile of a design layout 226, the design generation application 220 can determine the surface type and/or construction type associated with the geometric element, and retrieve and enter a set of energy properties associated with the surface type and/or construction type into an element entry 501 in the design-layout table 500 corresponding to the geometric element. The design generation application 220 can iterate through each geometric element in the design layout 226 to determine the corresponding set of energy properties based on the associated surface type and/or construction type, and enter the corresponding set of energy properties in the design-layout table 500 for each geometric element. In this manner, the design generation application 220 can automatically embed energy metadata into the design layout 226 via the associated design-layout table 500. In other embodiments, the user can enter the set of energy properties for each geometric element of the design layout 226 or some each geometric elements (such as for non-standard surface types and/or construction types).

In some embodiments, the design-layout table 500 is used to enable the embedding of energy metadata within the design layout 226. In other embodiments, the design-layout table 500 is conceptual in nature only and serves to illustrate that associated energy properties are linked to the geometric elements and tiles of the corresponding design layout 226 in some manner to enable the embedding of energy metadata within the design layout 226. For example, in other embodiments, each geometric element in the design layout 226 can be associated with a unique Identifying ID (UUID) that uniquely identifies the geometric element, whereby an embedded database links each UUID to a set of energy properties.

### Third Phase: Generating Energy Models for the Design Layouts

Notably, a design layout 226 generated by the design generation application 220 in the second phase is not executable by a simulation application 240 since the design layout 226 is not in a simulation-compliant format that is executable by a simulation application 240. As such, in the third phase, the design workflow application 202 causes/initiates the energy-model application 230 to automatically generate an energy model 232 for each generated design layout 226, whereby each energy model 232 is a valid energy model that is in a simulation-compliant format executable by a simulation application 240.

In general, a design layout 226 can comprise a 3D geometric model of a building which is not executable/useable by the simulation application 240, and thus is converted into a simulation-ready format comprising an analytical energy model 232. The energy model 232 can comprise a 3D geometric model that includes a more simplified geometry relative to the corresponding design layout 226, the simplified geometry being formatted in a specific way that is compliant with the simulation format. The simplified geometry of the energy model 232 is tagged/labeled with energy properties that are processed and analyzed by the simulation application 240 to generate simulation results for the energy model 232 and corresponding design layout 226. In some embodiments, an energy model 232 comprises Building Energy Model (BEM) geometry that is formatted in the OpenStudio data format (.osm) or another industry standard format, such as Green Building XML format (gbXML), comprising a standard input to an energy-simulation (energy-analysis) solver.

The energy-model application 230 generates the geometry of the energy model 232 by assembling/stitching together the set of tiles of the corresponding design layout 226 based on the arrangement of the set of tiles in the corresponding design layout 226. The energy-model application 230 can do so by eliminating tile seams and combining the tiles/surfaces into a contiguous hermetic/sealed 3D model comprising the energy model 232. For example, the energy-model application 230 can identify matching geometric elements/surfaces of the design layout 226 that are geometrically aligned (having coincident vertices and are co-planar) and that have a matching surface type and construction type. The matching geometric elements/surfaces of the design layout 226 can then be merged through Boolean union operations to produce a single, contiguous and resolved surface of the energy model 232 that is ready for simulation. The resulting energy model 232 is composed of geometric objects/surfaces (BEM geometries) with tagged/attached energy properties. In this manner, the geometric elements/surfaces of the design layout 226 have been merged into a single set of BEM data comprising the energy model 232.

To generate the energy model 232 for a corresponding design layout 226, the energy-model application 230 also automatically extracts the energy properties embedded in the geometric elements of the set of tiles of the corresponding design layout 226 and tagging/labeling the energy model 232 with the extracted energy properties. For example, the energy-model application 230 can extract the energy properties for the corresponding design layout 226 from the associated design-layout table 500 storing energy properties for each geometric element of each tile of corresponding design layout 226. The resulting energy model 232 can comprise a hermetic/sealed 3D model with specific energy properties tagged/labeled for various sub-portions of the energy model 232. In general, the energy model 232 can comprise a plurality of sub-portions, each sub-portion comprising a geometric object of the energy model 232 that can correspond to a particular geometric element/surface of the design layout 226. The energy-model application 230 can automatically extract the energy properties embedded in the geometric element/surface of the design layout 226 and tag/label the corresponding geometric object of the energy model 232 with the extracted energy properties.

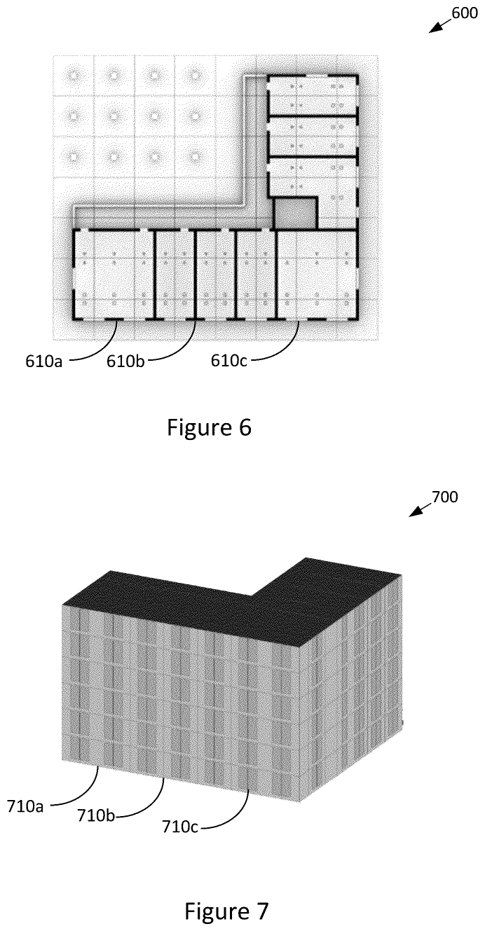

FIG. 6 illustrates an example design layout 600 selected for an energy-analysis simulation, according to various embodiments. As shown, the design layout 600 includes a set of geometric elements 610 (that include for example, geometric elements 610a, 610b, 610c). The design layout 600 represents a layout of a single floor of the building, whereby the single floor can be stacked to generate multiple floors of the building comprising a 3D model of the building. FIG. 7 illustrates an energy model 700 generated for the design layout 600 of FIG. 6, according to various embodiments. In the example of FIGS. 6-7, the design layout 600 of the single floor is stacked to generate a 3D model of a building having six floors. As such, the energy model 700 comprises a 3D energy model of a building having six floors.

As shown in FIG. 7, the energy model 700 includes a set of geometric objects 710 (that include for example, geometric objects 710a, 710b, 710c). Each geometric object of the energy model 700 can correspond to a particular geometric element 610 of the design layout 600, whereby the energy-model application 230 automatically extracts the energy properties embedded in the geometric element 610 and tags/attaches the corresponding geometric object 710 of the energy model 700 with the extracted energy properties. The energy-model application 230 can automatically iterate through each geometric element 610 of the corresponding design layout 226 to tag/label each geometric object 710 of the energy model 700 with the extracted energy properties.

In this manner, the energy-model application 230 can generate an energy model 700 that accurately represents the energy properties of the corresponding design layout 600. Advantageously, the energy-model application 230 can generate, in an automated manner, a valid and accurate energy model 232 for a design layout 226 that correctly represents the energy properties of the design layout 226. Thus, when the energy model is executed by a simulation application 240, the simulation application 240 provides simulation results that accurately represent the energy properties of the corresponding design layout 226, allowing the user to make well-informed design decisions for the building project.

### Fourth Phase: Configuring Simulations on the Energy Models

The fourth phase for configuring the simulations on the energy models 232 can include configuring multiple different simulations for multiple different energy models 232 corresponding to multiple different design layouts 226 and/or configuring multiple different simulations for a same energy model 232 corresponding to a same design layout 226 with different simulation configurations via the design workflow application 202. For each separate simulation, the design workflow application 202 receives a selected energy model 232 of a selected design layout 226 and a set of simulation input parameters that specify the simulation configuration of the selected energy model 232.

The set of simulation input parameters that define a particular simulation configuration can include, without limitation, the location climate data 242, a climate-conditioning mode 244, an occupancy model 246, and/or a comfort model 248. The simulation results 250 and comparative results 252 for an executed simulation are affected by the selected energy model 232/design layout 226 and each of the simulation input parameters. The design workflow application 202 generates a user interface for receiving user inputs in the fourth phase and for displaying the separate simulation results 250 and comparative results 252 in the fifth phase.

For each simulation, the design workflow application 202 can receive, via the user interface, a user selection of a particular energy model 232 for a particular design layout 226. The selected energy model 232/design layout 226 can include the building orientation, or the building orientation can be included as a separate simulation input parameter. The building orientation of an energy model 232/design layout 226 can greatly affect the simulation results of the energy model 232/design layout 226.

For each simulation, the design workflow application 202 can also receive, via the user interface, a user selection of a proposed building location. The design workflow application 202 can then receive location climate data 242 corresponding to the proposed building location. In other embodiments, the design workflow application 202 can automatically retrieve (for example, from a weather database) the location climate data 242 corresponding to the proposed building location. The location climate data 242 can include climate data for one of several climate zones. For example, climate zones can be defined as a combination of temperature (Zones 1 to 8) and relative humidity (Zones A to C), such as the cities of Houston (2A), Phoenix (2B), Atlanta (3A), Los Angeles (3B), Las Vegas (3B), and San Francisco (3C). The location climate data 242 can include historical weather data files in various forms, such as tables, graphs, charts, or a stream of weather metadata. The weather data files can be formatted in standard file formats such as TMY, EPW, or WEA.

The location climate data 242 can specify one or more weather parameters, such as temperature, relative humidity, wind direction, and the like that are associated with the building location across one or more months of one or more past years. In other embodiments, the location climate data 242 specifies one or more weather parameters associated with the building location across one or more months of one or more future years. In these embodiments, the location climate data 242 includes values of the one or more weather parameters that are predicted to occur in one or more future years. For example, the location climate data 242 can include values of temperature and relative humidity that are predicted to occur in the next 10 years due to climate change/global warming.

For each simulation, the design workflow application 202 can also receive, via the user interface, a user selection of a climate-conditioning mode 244. The climate-conditioning modes 244 can include, without limitation, HVAC only, NV only, or MM. The HVAC only mode indicates use of a traditional artificial HVAC system for providing the climate conditioning within the building. However, natural ventilation (NV) systems are increasing in popularity due to the possible reduction in energy usage of the buildings relative to using only an HVAC system. As buildings account for roughly 30% of global final energy use and over 55% of global electricity consumption, passive and natural climate-conditioning strategies for reducing heating/cooling loads in buildings have the potential to significantly mitigate energy consumption and carbon dioxide emissions in the building sector. NV climate conditioning is among the most potentially beneficial passive cooling techniques available for improving energy efficiency, indoor thermal comfort, and air quality in residential buildings. NV systems include purpose-built openings for ventilation, such as natural wind-induced airflow ventilation, the buoyancy (stack) effect ventilation, or hybrid ventilation, that provide convective heat dissipation and increase evaporative heat loss from human bodies. Buildings implementing a multi-mode (MM) system that uses both an HVAC system and an NV system for climate conditioning are also becoming increasing popular due to the potential improvements in energy efficiency relative to using only an HVAC system.

The HVAC only mode indicates that the climate-conditioning strategy to be implemented in the building includes only a traditional heating, ventilation, and air conditioning (HVAC) system, without use of an NV system. The HVAC mode/system can operate under the assumption that all windows are closed and the HVAC system is turned on to ensure the indoor temperature is within the acceptable comfort range specific for an HVAC system (such as between 21.7° C. and 24.4° C.).

The NV only mode indicates that the climate-conditioning strategy to be implemented in the building includes only a natural ventilation (NV) system, without use of an HVAC system. The NV mode/system can operate under the assumption that the HVAC system is turned off, windows are opened or closed to ensure the room temperatures between is within the acceptable comfort ranges specific for an NV system (such as between 21° C. and 28° C.), windows are opened or closed only when outdoor temperature is at least 3° C. lower than indoor temperature as the main purpose of the window operation is for space cooling, and the windows are operated while the outside temperature is in the range of 18° C. to 25° C.

The MM mode indicates that the climate-conditioning strategy to be implemented in the building includes both an HVAC system and an NV system. In general, the MM mode/system can operate under the assumption that when the NV system is inadequate to provide acceptable occupant comfort ranges within the building, the HVAC system will be turned on to do so. In particular, the MM mode can perform under the assumption that the windows are operable the same as in NV mode, the HVAC will be turned on if the indoor temperature is outside the acceptable comfort range for an NV system (such as lower than 21° C. or higher than 28° C.). In some embodiments, when the MM system is operating in HVAC mode, the acceptable comfort range specific for an HVAC system is applied. When the MM system is operating in NV mode, the acceptable comfort range specific for an NV system is applied.

For each simulation, the design workflow application 202 can also receive, via the user interface, a user selection of an occupancy model 246. An occupancy model 246 specifies a predicted occupancy level of a building across one or more hours of a day in a given year. In some embodiments, the occupancy model 246 can specify a first predicted occupancy level for weekdays and a second predicted occupancy level for weekends. A conventional occupancy model specifies a predicted occupancy level of the building during one or more hours of the day based on typical pre-COVID occupancy behaviors/patterns. However, since the outbreak of COVID-19, traditional workplace behaviors and practices have undergone a drastic transformation with more people working from home than ever before, with expectations that this trend will continue in the future. The shift in workplace behaviors and practices has altered the pattern of HVAC usage and electricity consumption in residential building and non-residential buildings, such as offices or other workplace buildings.

To account for the changes in occupancy behaviors/patterns that have occurred due to COVID, an occupancy model 246 can comprise, for example, an occupancy model based on during-COVID occupancy behaviors/patterns or post-COVID occupancy behaviors/patterns. In these embodiments, the user can select between a first occupancy model based on pre-COVID occupancy behaviors/patterns, a second occupancy model based on during-COVID occupancy behaviors/patterns, or a third occupancy model based on post-COVID occupancy behaviors/patterns as the occupancy model 246 for the simulation. In these embodiments, the user can select between different occupancy models that are based on occupancy behaviors/patterns of different time periods that are defined relative to a pandemic event, such as pre-COVID, during-COVID, and post-COVID time periods. Using an updated and currently accurate occupancy model 246 for the simulation will ensure that the simulation will likewise return accurate simulation results (such as energy and comfort performance metrics) for the user to make well-informed design decisions.

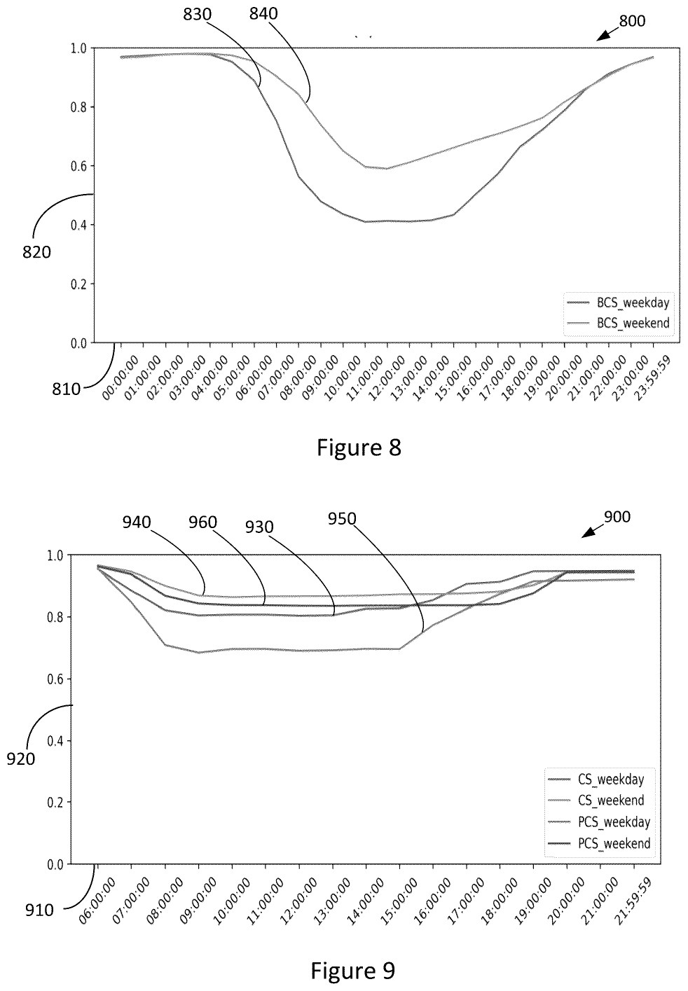

FIG. 8 shows a conceptual illustration of an occupancy model 800 based on pre-COVID occupancy behaviors of a residential building, according to various embodiments. As shown, the occupancy model 800 includes a graph comprising a first axis 810 and a second axis 820. The occupancy model 800 can be based on, for example, pre-COVID US residential occupancy profiles based on surveys by the US Census Bureau, or based on private occupant field surveys. The first axis 810 represents the time of day and the second axis 820 represents the occupancy level. In the example of FIG. 8, the occupancy level is specified as an occupancy fraction that indicates the average fraction of total building occupants that is predicted to be inside the building at a particular time of the day. An occupancy fraction value of 1 indicates that all occupants are predicted to be in the building and an occupancy fraction value of 0 indicates that none of the occupants are predicted to be in the building. The total building occupants can be based, for example, on an expected total number of occupants for the building or a maximum number of occupants allowed for the building. In other embodiments, the occupancy level can be specified in a different manner, such as the average number of occupants rather than an average occupancy fraction. A first graph line 830 represents the occupancy level for a before-COVID schedule for weekdays (BCS_weekday) and a second graph line 840 represents the occupancy level for a before-COVID schedule for weekends (BCS_weekend).

FIG. 9 shows a conceptual illustration of an occupancy model 900 based on during-COVID or post-COVID occupancy behaviors of a residential building, according to various embodiments. The occupancy model 900 can be based, for example, on during-COVID and post-COVID US residential occupancy profiles based on surveys by the US Census Bureau, or based on private occupant field surveys. As shown, the occupancy model 900 includes a graph comprising a first axis 910 and a second axis 920. The first axis 910 represents the time of day and the second axis 920 represents the occupancy level. In the example of FIG. 9, the occupancy level is specified as an average occupancy fraction that indicates the average fraction of total building occupants that is predicted to be inside the building at a particular time of the day, whereby a value of 1 indicates that all occupants are predicted to be in the building and a value of 0 indicates that none of the occupants are predicted to be in the building. The total building occupants can be based, for example, on an expected total number of occupants for the building or a maximum number of occupants allowed for the building. In other embodiments, the occupancy level can be specified in a different manner, such as the average number of occupants rather than an average occupancy fraction.

In some embodiments, the occupancy model 900 is based on during-COVID occupancy behaviors that include a first graph line 930 that represents the occupancy level for a during-COVID schedule for weekdays (CS_weekday) and a second graph line 940 that represents the occupancy level for a during-COVID schedule for weekends (CS_weekend). In other embodiments, the occupancy model 900 is based on post-COVID occupancy behaviors that include a third graph line 950 that represents the occupancy level for a post-COVID schedule for weekdays (PCS_weekday) and a second graph line 960 that represents the occupancy level for a post-COVID schedule for weekends (PCS_weekend).

Note that the occupancy models shown in FIGS. 8 and 9 are for residential buildings. A comparison between FIGS. 8 and 9 clearly shows that the occupancy level of residential buildings increased significantly from the pre-COVID to during-COVID time periods and also increased significantly from the pre-COVID to post-COVID time periods, especially during the midday hours where occupants are working when natural ventilation is most effective. However, if a non-residential workplace building is being designed and the occupancy models are for a non-residential workplace building, then the occupancy models from the pre-COVID to during-COVID time periods and from the pre-COVID to post-COVID time periods would show the opposite trend in occupancy behaviors. In other words, the occupancy level of non-residential workplace buildings would decrease significantly from the pre-COVID to during-COVID time periods and also decrease significantly from the pre-COVID to post-COVID time periods, especially during the mid-day hours where occupants are working.

In other embodiments, an occupancy model 246 can include different and/or more detailed information than shown in FIGS. 8 and 9. For example, an occupancy model 246 can specify occupancy schedules for a set of time intervals (such as hourly), total occupant load (total number of occupants), lighting load (on/off/intensity percentage), temperature set-point (in ° C.), fan operation (0-1), window operation (0-1), blind operation (0-1), and/or occupancy levels for particular parts of the building (such as a corridor or a specific room).

For each simulation, the design workflow application 202 can also receive, via the user interface, a user selection of a comfort model 248 from a plurality of different comfort models 248. In general, a comfort model 248 specifies a comfort range that is predicted to be acceptable to occupants in a building based on one or more climate parameters, such as temperature, humidity, relative humidity, or any combination thereof. Humidity indicates the amount of water vapor in a specific volume of air, whereas relative humidity indicates the ratio of the amount of water vapor in the air to the maximum amount the air can hold at the same temperature expressed as a percentage.

For example, a comfort model 248 can specify a comfort range comprising a temperature range, such as between 21.7° C. and 24.4° C., that is predicted to be acceptable to occupants in a building, whereby the climate conditioning inside the building is within the comfort range when the temperature inside the building is within the temperature range. For example, a comfort model 248 can specify a comfort range comprising a relative humidity range, such as between 30% and 50%, that is predicted to be acceptable to occupants in a building, whereby the climate conditioning inside the building is within the comfort range when the relative humidity inside the building is within the relative humidity range. In other embodiments, the comfort model 248 can specify a comfort range that is based on both a temperature range and a relative humidity range. For example, a comfort model 248 can specify a comfort range comprising a temperature range and a relative humidity range that is predicted to be acceptable to occupants in a building, whereby the climate conditioning inside the building is within the comfort range when both the temperature inside the building is within the temperature range and the relative humidity inside the building is within relative humidity range.

The user can select from a plurality of different comfort models 248, including a Predicted Mean Vote (PMV) model, an adaptive comfort model (ACM) model, an exceedance comfort model. A PMV model is a standardized comfort model 248 that specifies a comfort range that is acceptable to occupants in a building implementing the HVAC only mode. The PMV model reflects a statistical likelihood that most occupants will consider a space comfortable depending on the temperature and/or humidity in a steady state environment, such as in a space implementing an HVAC system and not an NV system.

An ACM model is a comfort model 248 that specifies a first comfort range predicted to be acceptable to occupants during the HVAC mode and a second comfort range predicted to be acceptable to occupants during the NV mode. Studies have shown that an acceptable comfort range for occupants in a building operating an HVAC system can be significantly different from an acceptable comfort range for occupants in a building operating an NV system, whereby the occupants in a building operating an NV system are found to have a greater acceptable comfort range in both temperature and humidity. An exceedance comfort model is a comfort model 248 that specifies a comfort range predicted to be acceptable to occupants during the NV mode. The exceedance comfort model is based on the assumption that the climate inside the building will not always be in the comfort range, but that occupants have some limited tolerance for discomfort that could be considered as a tradeoff for lower energy consumption. Thus, the exceedance comfort model will typically specify a greater comfort range relative to the PMV or ACM models.

Conventional comfort models 248 typically specify a comfort range predicted to be acceptable to “standard” occupants, which is typically only male office workers dressed in business attire. However, a conventional comfort model 248 does not consider specific demographic-based factors of the expected occupants of the proposed building, and is only based on a generic “standard” occupant. When configured with an inaccurate comfort model 248 that does not accurately represent the expected occupants of the building, the energy-analysis simulation will likewise return inaccurate simulation results for a corresponding energy model 232 and design layout 226, except when the expected occupants match the “standard” occupants.

In some embodiments, a comfort model 248 comprises an occupant demographic-based comfort model that specifies a comfort range predicted to be acceptable to occupants of a specific demographic group rather than a conventional comfort range that is predicted to be acceptable to “standard” occupants. For example, a demographic-modified PMV model, demographic-modified ACM model, and/or a demographic-modified exceedance comfort model can each specify a demographic-modified comfort range that is predicted to be acceptable to expected occupants of a specific demographic group, which is different from the conventional comfort range that is predicted to be acceptable to “standard” occupants. In addition, a large number of demographic-based comfort models can be generated in this manner based on different demographic groups of occupants. In these embodiments, the user can then select from a plurality of different comfort models 248, including a plurality of conventional comfort models that are based on “standard” occupants and a plurality of different demographic-based comfort models that are based on different demographic groups of occupants.

In some embodiments, the demographic-based comfort models are based on different demographic groups including different cultures, different genders, or different income/socio-economic levels. Research and studies have shown that such different demographic groups have different comfort ranges that are deemed acceptable to the demographic groups, thus affecting when the occupants would turn on the HVAC system and use more energy for climate conditioning. The plurality of different demographic-based comfort models can specify these different comfort ranges based on the different cultures, different genders, or different income/socio-economic levels.

For example, occupant groups of different cultures can dress in different types of clothes/attire, resulting in different acceptable comfort ranges for these different occupant groups. Thus, a first demographic-based comfort model based on a first culture for a first expected occupant group can specify a first comfort range, and a second demographic-based comfort model based on a second culture for a second occupant group can specify a second comfort range, wherein the second culture is different from the first culture and the second comfort range is different than the first comfort range.

For example, studies have shown that an occupant group of females can have a significantly different perception of a comfortable range of temperature and humidity than an occupant group of males. Thus, a first demographic-based comfort model based on a first occupant group of females can specify a first comfort range, and a second demographic-based comfort model based on a second occupant group of makes can specify a second comfort range that is different than the first comfort range. For example, the demographic-based comfort model based on the female gender could be used for a building comprising a female-only dormitory or female-only gym. Likewise, the demographic-based comfort model based on the male gender could be used for a building comprising a male-only dormitory or male-only gym.

For example, studies have shown that occupant groups of lower income/socio-economic levels can have a significantly different perception of a comfortable range of temperature and humidity than occupant groups of higher income/socio-economic levels. Thus, a first demographic-based comfort model based on a first income/socio-economic level for a first expected occupant group can specify a first comfort range, and a second demographic-based comfort model based on a second income/socio-economic level for a second occupant group can specify a second comfort range, wherein the second income/socio-economic level is different from the first income/socio-economic level and the second comfort range is different than the first comfort range. For example, the demographic-based comfort model based on a low income/socio-economic level could be used for a building intended for low-income housing. Likewise, the demographic-based comfort model based on a high income/socio-economic level could be used for a building intended for high-income housing.

In addition, the plurality of different demographic-based comfort models can be based on different combinations of different demographic groups. For example, a first demographic-based comfort model can be based on a first culture and the female gender, a second demographic-based comfort model can be based on a first culture and the male gender, a third demographic-based comfort model can be based on a second culture and a first income/socio-economic level, a fourth demographic-based comfort model can be based on the female gender and a second income/socio-economic level, and so forth. In this manner, a demographic-based comfort model can be based on any combination of the different demographic groups.

Each demographic-based comfort model can specify a particular comfort range (such as a temperature range and/or relative humidity range) that is determined from studies, research, and/or field surveys that are specific to the particular demographic group. In other embodiments, the design workflow application 202 provides a user interface for the user to specify a particular comfort range for a demographic-based comfort model.

Advantageously, the disclosed techniques can implement more accurate comfort models that are tailored to the specific demographic group of occupants that are expected to occupy the proposed building. When performing energy-analysis simulations using the more accurate comfort models will provide more accurate simulation results relative to prior approaches using comfort models that are not specific to the demographic group of expected occupants, which enable the user to make better informed design decisions relative to prior approaches.

In the fourth phase, the design workflow application 202 generates a user interface for receiving and displaying user inputs to configure multiple simulations, such as multiple different simulations for multiple different energy models 232 corresponding to multiple different design layouts 226 and/or configuring multiple different simulations for a same energy model 232 corresponding to a same design layout 226 with different simulation configurations. For each separate simulation, the design workflow application 202 receives a selected energy model 232 of a selected design layout 226 and a set of simulation input parameters that specify the simulation configuration of the selected energy model 232. Each simulation for an energy model 232 can include any combination of the different simulation input parameters that specify the simulation configuration of the energy model 232.

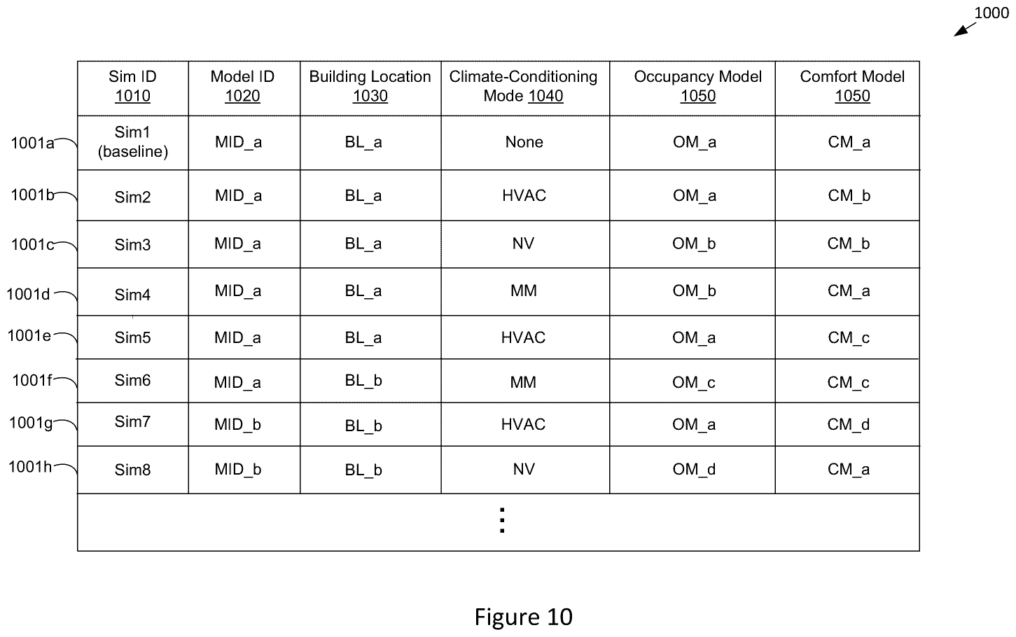

FIG. 10 illustrates a configuration interface 1000 of the design workflow application 202 for configuring multiple simulations, according to various embodiments. As shown, the configuration interface 1000 can be used to configure a plurality of different simulations 1001 (such as 1001a, 1001b, 1001c, etc.). Each configured simulation 1001 has a plurality of associated fields, including a simulation ID (Sim ID) 1010, energy model ID (Model ID) 1020, building location 1030, climate-conditioning mode 1040, occupancy model 1050, and a comfort model 1060.

The simulation ID 1010 uniquely identifies each simulation 1001 within the plurality of different simulations 1001. The user selects a particular energy model 232 from a plurality of energy models 232 for the simulation 1001, whereby the energy model ID 1020 uniquely identifies the selected energy model 232 within the plurality of energy models 232. The user selects a particular building location 1030 from a plurality of building locations 1030 for the simulation 1001. The user can enter location climate data 242 associated with the building location 1030 or the design workflow application 202 can automatically retrieve (for example, from a weather database) the location climate data 242 associated with the building location 1030.

The user selects a particular climate-conditioning mode 1040 for the simulation 1001 from a plurality of climate-conditioning modes 244, such as HVAC only, NV only, or MM. Note that the baseline simulation (Sim1) 1001a does not include a climate-conditioning mode 1040 as the baseline simulation includes neither an HVAC mode nor NV mode selection and determines energy and comfort performance as if there no HVAC system or NV system is implemented in the building to represent a tradeoff between a lowest energy cost level and lowest comfort level. The user selects a particular occupancy model 1050 for the simulation 1001 from a plurality of different occupancy models 246, such as occupancy models 246 based on pre-COVID, during COVID, or post-COVID occupancy patterns. The user selects a particular comfort model 1060 for the simulation 1001 from a plurality of different comfort models 248, such as various conventional comfort models or various demographic-based comfort models.

### Fifth Phase: Executing Simulations and Generating Comparative Results

The fifth phase for executing the configured simulations and generating comparative results includes the design workflow application 202 loading the configured simulations to the simulation application 240 and causing/initiating the simulation application 240 to execute each configured simulation for generating separate simulation results 250 for each configured simulation. The fifth phase further includes the design workflow application 202 generating comparative results 252 based on an analysis and comparison of the simulation results 250 of two or more different configured simulations. The design workflow application 202 also displays the separate simulation results 250 and comparative results 252 in the fifth phase via the user interface.

For each configured simulation, the design workflow application 202 can package the energy model 232 and the set of simulation input parameters into a single simulation input file for inputting to the simulation application 240 for execution of the simulation, the single file being in a format compatible with the simulation application 240. For example, the simulation application 240 can comprise the industry standard OpenStudio energy-simulation (energy-analysis) solver (which includes the building energy-simulation solver EnergyPlus) that is approved by the U.S. Department of Energy and the single input file is formatted in the OpenStudio data format (.osm). In other embodiments, the simulation application 240 can comprise another type of energy-simulation (energy-analysis) solver and the single input file can be formatted in a different format, such as the Green Building XML format (gbXML).

For each configured simulation of a plurality of configured simulations, the design workflow application 202 can load the simulation input file for the configured simulations to the simulation application 240 for execution. In this manner, multiple configured simulations can be simultaneously/concurrently executed by the simulation application 240 to simultaneously/concurrently generate simulation results 250 for the multiple configured simulations. The simulation results 250 for each configured simulation includes one or more energy performance metrics and/or one or more comfort performance metrics. Each energy performance metric can indicate a level of energy efficiency or energy consumption of the corresponding energy model 232 and design layout 226 in providing thermal comfort for occupants inside the building (climate conditioning). Each comfort performance metric can indicate a level of occupant comfort achieved by the corresponding energy model 232 and design layout 226 when providing the climate conditioning inside the building.

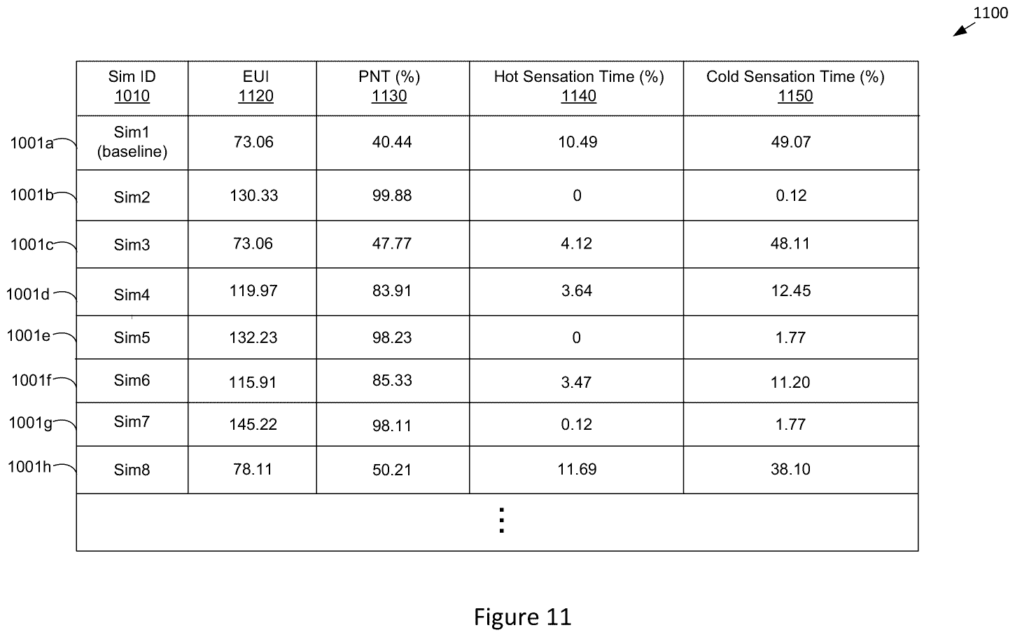

The design workflow application 202 receives the simulation results 250 for the multiple configured simulations from the simulation application 240 and displays the simulation results 250 in the user interface. FIG. 11 illustrates a simulation results interface 1100 of the design workflow application 202 for displaying simulation results of multiple simulations, according to various embodiments. As shown, the simulation results interface 1100 displays simulation results for the plurality of configured simulations 1001 (such as 1001a, 1001b, 1001c, etc.) shown in FIG. 10. For each configured simulation 1001, a plurality of energy and comfort performance metrics are generated and displayed, including energy use intensity (EUI) 1120, percentage of neutral time (PNT) 1130, hot sensation time percentage 1140, and cold sensation time percentage 1150.

The energy use intensity (EUI) 1120 is an energy performance metric that indicates how much energy is used in relation to size for a building represented by the corresponding energy model 232 and design layout 226. The EUI 1120 can be calculated by dividing the total energy the building consumes for providing climate conditioning in a year by its total gross floor area. In the examples shown in FIG. 11, EUI 1120 represents kilowatt-hour (kWh) per square meter per year, which is expressed as kWh/sq. m/year. In other embodiments, EUI 1120 can represent thousands of British thermal units (kBtu) per square foot per year, which is expressed as kBtu/sq. ft./year. In further embodiments, EUI 1120 can be expressed in other forms. The higher the value of EUI 1120 indicates higher energy consumption and a lower energy performance of the corresponding energy model 232 and design layout 226. In contrast, the lower the value of EUI 1120 indicates higher energy efficiency and a higher energy performance of the corresponding energy model 232 and design layout 226.

The percentage of neutral time (PNT) 1130 is a comfort performance metric that indicates the percentage of time that the climate within a building represented by the corresponding energy model 232 and design layout 226 is within the specified comfort range (as specified by the selected comfort model 248). PNT 1130 can also be referred to a comfort-time percentage. The higher the value for PNT 1130 indicates a greater level of thermal comfort for occupants and a higher comfort performance of the corresponding energy model 232 and design layout 226.

The hot sensation time percentage 1140 is a comfort performance metric that indicates the percentage of time that the climate within a building represented by the corresponding energy model 232 and design layout 226 is hotter than (above) the specified comfort range (as specified by the selected comfort model 248). The lower the value for hot sensation time percentage 1140 indicates a greater level of thermal comfort for occupants and a higher comfort performance of the corresponding energy model 232 and design layout 226. The cold sensation time percentage 1150 is a comfort performance metric that indicates the percentage of time that the climate within a building represented by the corresponding energy model 232 and design layout 226 is colder than (below) the specified comfort range (as specified by the selected comfort model 248). The lower the value for cold sensation time percentage 1150 indicates a greater level of thermal comfort for occupants and a higher comfort performance of the corresponding energy model 232 and design layout 226.

For each simulation 1001, the simulation results interface 1100 of the design workflow application 202 displays energy and comfort performance metrics that show a trade-off between how much energy is used to provide climate conditioning in the building and how comfortable occupants will be inside the building. In other embodiments, the simulation results interface 1100 of the design workflow application 202 can display other simulation results 250 than those shown in FIG. 11. In further embodiments, the simulation results interface 1100 can display other simulation results 250 in different forms, such as graphs, charts, heat maps, and the like. For example, the simulation results interface 1100 can display a comfort condition graph that visually illustrates the comfort distribution over a given time.

However, the separate simulation results 250 for the multiple different simulations 1001 shown in FIG. 11 do not provide any comparative results based on an analysis of the simulation results 250 of the multiple different simulations 1001. As such, the separate simulation results 250 do not provide the user with meaningful insight into the different energy and comfort characteristics of different design layouts and/or different simulation configurations. In some embodiments, the design workflow application 202 generates and displays comparative results 252 based on an analysis of the simulation results 250 for two or more different simulations 1001.

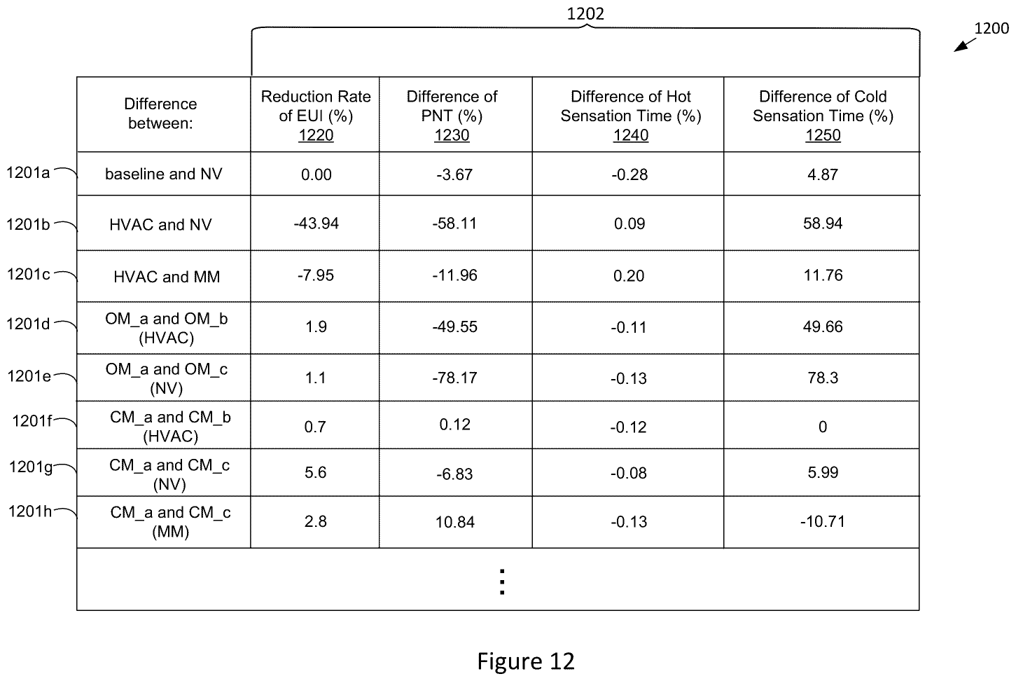

In some embodiments, for a same energy model 232 and design layout 226 with multiple different simulation configurations, the comparative results 252 can include comparative metrics that compare energy or comfort performance metrics of two or more different simulation configurations in relation to two different simulation input parameters. FIG. 12 illustrates a comparative results interface 1200 of the design workflow application 202 for displaying comparative results 252 of multiple simulations, according to various embodiments. As shown, the comparative results interface 1200 displays comparative metrics 1202 for a plurality of simulation input pairs 1201 (such as 1201a, 1201b, 1201c, etc.). The example of FIG. 12 relates to the same energy model 232 and design layout 226 and a same building location having the same location climate data 242.

As shown, each simulation input pair 1201 specifies two different simulation input parameters that are to be compared in terms of energy or comfort performance as selected by the user. A simulation input pair 1201 can specify any combination of the simulation input parameters, such as a comparison between two different climate-conditioning modes 244, two different occupancy models 246, or two different comfort models 248. For example, the simulation input pair 1201b specifies a comparison between two different climate-conditioning modes 244 (HVAC and NV), the simulation input pair 1201d specifies a comparison between two different occupancy models 246 (OM_a and OM_b) while in HVAC mode, the simulation input pair 1201g specifies a comparison between two different comfort models 248 (CM_a and CM_c) while in NV mode, and so forth.

For each simulation input pair 1201, a set of comparative metrics 1202 are generated and displayed to indicate any differences in energy or comfort performance metrics for the simulation input pair 1201. As shown, the comparative metrics 1202 include reduction rate of EUI 1220, difference of PNT 1230, difference of hot sensation time 1240, and difference of cold sensation time 1250. The reduction rate of EUI 1220 indicates the percentage of reduction in EUI between the simulation input pair 1201. The difference of PNT 1230 indicates the percentage of difference in PNT between the simulation input pair 1201. The difference of hot sensation time 1240 indicates the percentage of difference in hot sensation time between the simulation input pair 1201. The difference of cold sensation time 1250 indicates the percentage of difference in cold sensation time between the simulation input pair 1201. The set of comparative metrics 1202 can be used for comparatively analyzing the energy and comfort performance of a same design layout 226 using different climate-conditioning modes 244, different occupancy models 246, or different comfort models 248.

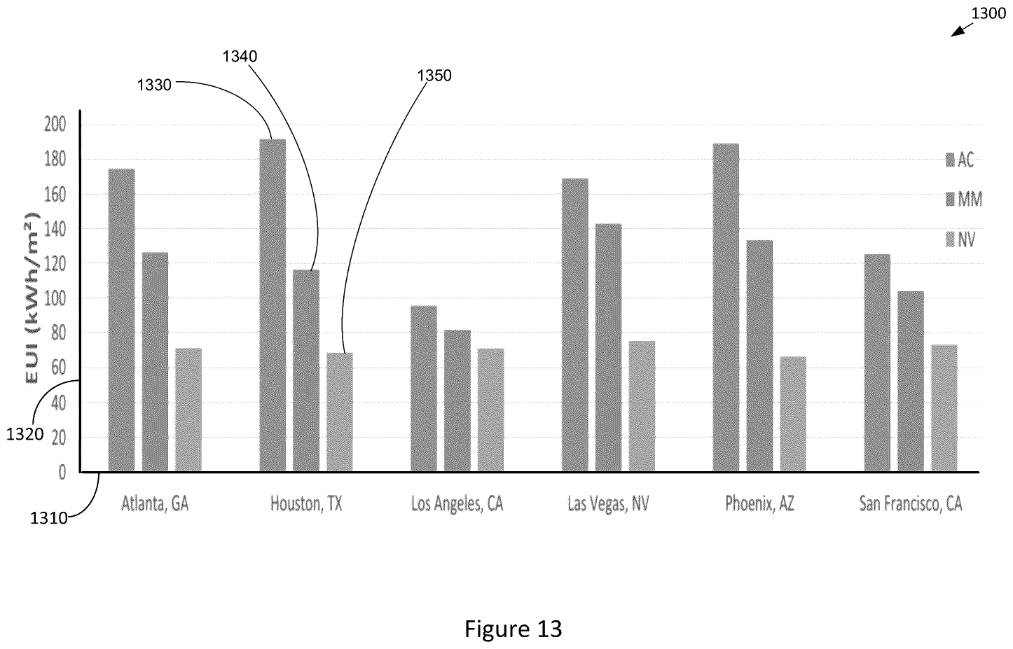

In other embodiments, the comparative results 252 of multiple simulations are displayed in a different manner than the text and table example shown in FIG. 12, such as in graphs, charts, heat maps, and the like. FIG. 13 illustrates a comparative graph interface 1300 of the design workflow application 202 for displaying energy-based comparative results, according to various embodiments. The comparative graph interface 1300 illustrates differences in energy performance between different building locations for different climate conditioning modes 244 for a same energy model 232 and design layout 226, a same occupancy model 246, and a same comfort model 248.

As shown, the comparative graph interface 1300 includes a first axis 1310 and a second axis 1320. The first axis 1310 shows different building locations, which would each have different location climate data 242. The second axis 1320 represents the EUI level in kWh/sq. m/year. For each building location, the EUI level is shown for different climate-conditioning modes 244, including a first bar 1330 showing the EUI level for the HVAC mode, a second bar 1340 showing the EUI level for the MM mode, and a third bar 1350 showing the EUI level for the NV mode. As shown, the EUI level is lowest and thus the energy performance is highest for the NV mode across all building locations, the EUI level is highest and thus the energy performance is lowest for the HVAC mode across all building locations, and the EUI level is in the middle and thus the energy performance is in the middle for the MM mode across all building locations.

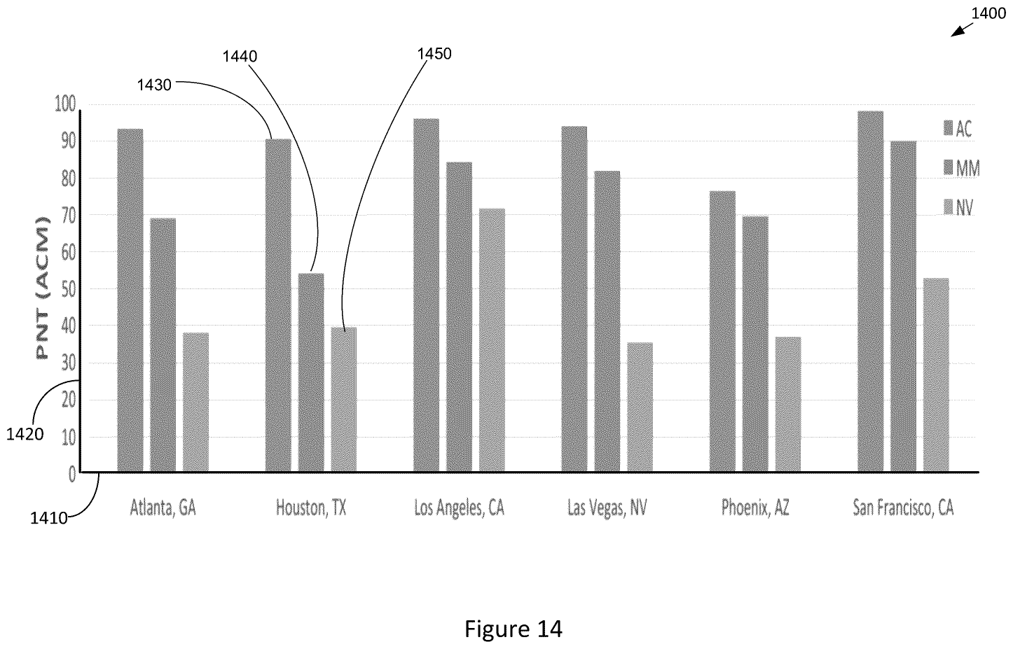

FIG. 14 illustrates a comparative graph interface 1400 of the design workflow application 202 for displaying comfort-based comparative results, according to various embodiments. The comparative graph interface 1400 illustrates differences in comfort performance between different building locations for different climate conditioning modes 244 for a same comfort model 232 and design layout 226, a same occupancy model 246, and a same comfort model 248.

As shown, the comparative graph interface 1400 includes a first axis 1410 and a second axis 1420. The first axis 1410 shows different building locations, which would each have different location climate data 242. The second axis 1420 represents the PNT level. For each building location, the PNT level is shown for different climate-conditioning modes 244, including a first bar 1430 showing the PNT level for the HVAC mode, a second bar 1440 showing the PNT level for the MM mode, and a third bar 1450 showing the PNT level for the NV mode. As shown, the PNT level is highest and thus the comfort performance is highest for the HVAC mode across all building locations, the PNT level is lowest and thus the comfort performance is lowest for the NV mode across all building locations, and the PNT level is in the middle and thus the comfort performance is in the middle for the MM mode across all building locations.

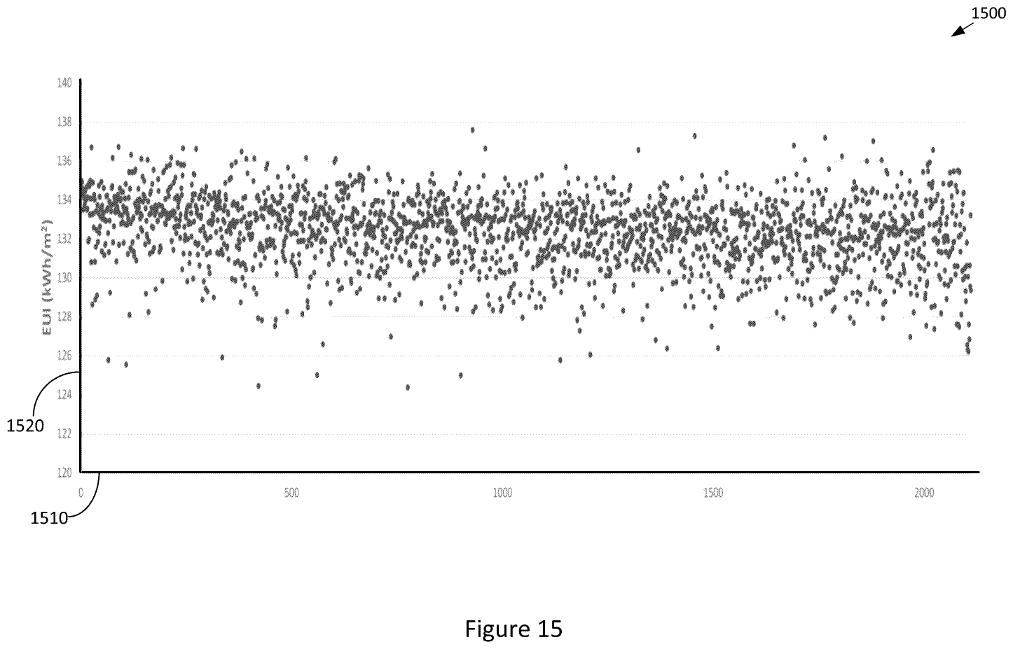

In some embodiments, for at least two different energy models 232 (corresponding to at least two difference design layouts 226) with the same simulation configurations, the comparative results 252 can illustrate differences in energy or comfort performance between the different energy models 232. FIG. 15 illustrates a design comparison interface 1500 of the design workflow application 202 for displaying design-based comparative results, according to various embodiments. The design comparison interface 1500 illustrates differences in energy performance between simulations for a large number of different energy models 232/design layouts 226, each simulation having the same simulation input parameters (the same location climate data 242, the climate-conditioning mode 244, the same occupancy model 246, and the same comfort model 248.

As shown, the design comparison interface 1500 includes a first axis 1510 and a second axis 1520. The first axis 1510 represents a design ID number that uniquely identifies each energy model 232/design layout 226 being simulated. As shown, there are over 2000 different energy models 232/design layouts 226 being simulated. The second axis 1520 represents the EUI level in kWh/sq. m/year. Each dot represents a specific EUI level for a specific energy model 232/design layout 226. As shown, the EUI levels of the energy models 232/design layouts 226 fall within the range of 124 (kWh/sq. m/year) and 138 (kWh/sq. m/year), but generally cluster in the middle of this EUI range.

In other embodiments, the design comparison interface 1500 can illustrate differences in comfort performance between simulations for a large number of different energy models 232/design layouts 226, each simulation having the same simulation input parameters (the same location climate data 242, the climate-conditioning mode 244, the same occupancy model 246, and the same comfort model 248. In these embodiments, the second axis 1520 can represent the PNT level rather than the EUI level. In further embodiments, the second axis 1520 can represent another comfort-based metric, such as hot sensation time percentage or cold sensation time percentage.

As shown, the comparative results 252 can provide valuable insights into the energy and comfort performance differences between simulation results of multiple different simulations. In this manner, the disclosed techniques provide meaningful insight into the different energy and comfort characteristics of different design layouts and/or different simulation configurations for a same design layout. This insight into the differences energy and comfort performance allow the user make well-informed design decisions and help the user evaluate energy and comfort tradeoffs between different design directions.

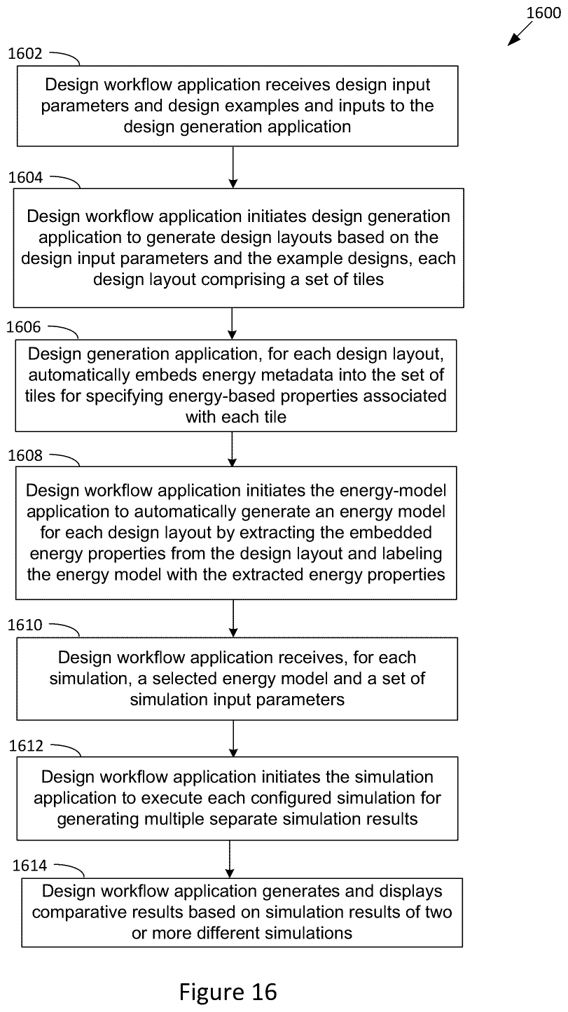

FIG. 16 sets forth a flow diagram of method steps for a design generation and simulation workflow, according to various embodiments. Although the method steps are described in conjunction with the systems of FIGS. 1-15, persons skilled in the art will understand that the method steps can be performed in any order by any system. In some embodiments, the method 1600 can be performed by the design workflow application 202 which controls/coordinates the initiation and execution of the design generation application 220, the energy-model application 230, and the simulation application 240 to perform the design generation and simulation workflow (design workflow).

At step 1602, the method 1600 begins in a first phase of the design workflow for configuring the design generation application 220, the design workflow application 202 receives design input parameters 224 and one or more design examples 222 from a user via a user interface and inputs the design input parameters 224 and one or more design examples 222 into the design generation application 220. The design input parameters 224 can specify design constraints and/or design objectives for generating design layouts 226 for a particular building project.

At step 1604, during a second phase of the design workflow, the design workflow application 202 causes/initiates the design generation application 220 to generate a plurality of design layouts 226 based on the design input parameters 224 and the one or more example designs 222. In some embodiments, each generated design layout 226 is a tile-based design layout comprising a set of tiles. At step 1606, for each generated design layout 226, the design generation application 220 automatically embeds energy metadata into the set of tiles specifying energy-based properties associated with each tile. In some embodiments, each tile includes one or more geometric elements, each geometric element representing a particular type of building surface and is associated with a particular construction type. In these embodiments, the design generation application 220 can automatically determine the energy properties associated with each geometric element based on the surface type and/or construction type of the geometric element, and embed the energy properties into the geometric element, for example, via a design-layout table 500 associated with the generated design layout 226.

At step 1608, during a third phase of the design workflow, the design workflow application 202 causes/initiates the energy-model application 230 to automatically generate an energy model 232 for each generated design layout 226. To generate an energy model 232 for a corresponding design layout 226, the energy-model application 230 extracts the energy properties embedded in the set of tiles of the design layout 226 and labels the energy model 232 with the extracted energy properties. Each energy model 232 is in a simulation-compliant format that is executable by a simulation application 240.

At step 1610, during a fourth phase of the design workflow for configuring a plurality of simulations for one or more energy models 232, the design workflow application 202 receives, for each simulation, a selected energy model 232 and a set of simulation input parameters from a user via the user interface. For each simulation, the set of simulation input parameters specify the simulation configuration of the selected energy model 232. The set of simulation input parameters can include, without limitation, the location climate data 242, the climate-conditioning mode 244, an occupancy model 246, and/or a comfort model 248. The location climate data 242 can include climate data associated with the building location. The climate-conditioning mode 244 can include, for example, an HVAC only mode, NV only mode, or MM mode. The occupancy model 246 can include, for example, an occupancy model based on pre-COVID occupancy behaviors, during-COVID occupancy behaviors, or post-COVID occupancy behaviors. The comfort model 248 can include, for example, a standardized comfort model or a demographic-based comfort model. The demographic-based comfort model can specify a comfort range predicted to be acceptable to occupants of a specific demographic group that is based, for example, on culture, gender, income level, and the like. In this manner, multiple different simulations can be configured for multiple different energy models 232 and/or multiple different simulations can be configured for a same energy model 232 with different simulation configurations via the design workflow application 202.

At step 1612, during a fifth phase of the design workflow, the design workflow application 202 loads the configured simulations to the simulation application 240 and causes/initiates the simulation application 240 to execute each configured simulation for generating separate simulation results 250 (such as energy and comfort performance metrics) for each configured simulation. At step 1614, the design workflow application 202 generates and displays comparative results 252 based on an analysis and comparison of the simulation results 250 of two or more different simulations. The method 1600 then ends.

In sum, the disclosed techniques include a design generation and simulation workflow (referred to herein as the “design workflow”) for generating design layouts and executing simulations of the design layouts to generate energy and comfort performance metrics that indicate the energy efficiency and occupant-comfort levels associated with the design layouts. As described herein, the design workflow includes five phases/stages including 1) configuring a design generation application, 2) generating design layouts via the design generation application, 3) generating energy models for the design layouts, 4) configuring simulations for the energy models, and 5) executing the configured simulations and generating comparative results based on simulation results of multiple simulations.

The first phase for configuring the design generation application includes entering design input parameters that specify design constraints and objectives for generating building design layouts for a particular building project. The first phase can also include selecting and entering design layout examples for analysis by the design generation application. The second phase for generating design layouts includes the design generation application generating a plurality of design layouts based on the design input parameters and the design layout examples. In some embodiments, each generated design layout is a tile-based design layout comprising a set of tiles that include embedded energy metadata specifying energy-based properties for each tile.

The third phase for generating energy models includes automatically generating an energy model for each design layout generated in the second phase via an energy-model application. Generating an energy model for a corresponding design layout includes extracting the energy properties embedded in the set of tiles of the design layout and labeling the energy model with the extracted energy properties. Each energy model is in a simulation-compliant format that is executable by a simulation application.

The fourth phase for configuring the simulations on the energy models can include configuring multiple different simulations for multiple different energy models and/or configuring multiple different simulations for a same energy model with different simulation configurations. For each separate simulation, the simulation application receives an energy model and a set of simulation input parameters that specify the simulation configuration of the received energy model. The set of simulation input parameters can include, without limitation, the building location, the climate conditioning strategy/mode (HVAC only, NV only, or MM), an occupancy model, and/or a comfort model. In some embodiments, the occupancy model can comprise an occupancy model based on post-COVID occupancy behaviors/patterns. In some embodiments, the comfort model can comprise a demographic-based comfort model. The fifth phase for executing the configured simulations and generating comparative results includes first executing each configured simulation for generating separate simulation results for each configured simulation via the simulation application. The fifth phase further includes generating and displaying comparative results based on the simulation results of two or more different simulations.

One technical advantage of the disclosed techniques relative to the prior art is an accurate energy model can be generated for a design layout in an automated manner. The design layout of a building is generated as a set of tiles, whereby each tile comprises a sub-portion of the design layout and represents a sub-portion of the building. Each tile includes embedded metadata that specifies one or more energy properties associated with the tile. The energy model can be generated from the design layout by automatically extracting the embedded metadata from the set of tiles of the design layout and tagging/labeling corresponding sub-portions of the energy model with the extracted metadata. In this manner, the disclosed techniques can automatically generate an accurate energy model that correctly represents the energy properties of the corresponding design layout. Thus, when the energy model is executed by a simulation application, the simulation application provides simulation results that accurately represent the energy properties of the corresponding design layout, which enable the user to make well-informed design decisions. As such, the disclosed techniques avoid the error-prone manual tagging/labeling process of prior techniques that often resulted in an energy model and simulation results that do not correctly represent the energy properties of the corresponding design layout. These technical advantages provide one or more technological improvements over prior art approaches.

Another technical advantage of the disclosed techniques relative to the prior art is that the disclosed techniques implement updated and accurate occupancy and comfort models when performing energy-analysis simulations. In some embodiments, an occupant demographic-based comfort model specifies a comfort range predicted to be acceptable to occupants of a particular demographic group that is based on culture, gender, income level, and the like. In some embodiments, an updated occupancy model can specify a predicted occupancy level based on post-COVID occupancy behaviors/patterns. In this manner, the disclosed techniques implement updated and more accurate occupancy and comfort models when performing energy-analysis simulations relative to prior approaches, thus providing more accurate simulation results (such as energy and comfort performance metrics) for the corresponding design layout relative to prior approaches, which enable the user to make well-informed design decisions. Another technical advantage of the disclosed techniques relative to the prior art is that the disclosed techniques generate and display comparative results that provide comparisons between simulation results from at least two different simulations. In this manner, the disclosed techniques provide meaningful insight into the different energy and comfort characteristics of different design layouts and/or different simulation configurations for a same design layout that is not provided in prior approaches. These technical advantages provide one or more technological improvements over prior art approaches.

Aspects of the subject matter described herein are set out in the following numbered clauses.

1. In some embodiments, a computer-implemented method for performing an energy-analysis simulation comprises generating a design layout of a building, the design layout including embedded metadata specifying a set of energy properties associated with the design layout, generating an energy model for the design layout based on the embedded metadata of the design layout, executing the energy-analysis simulation on the energy model to generate a set of simulation results, and displaying the set of simulation results.

2. The computer-implemented method of clause 1, wherein the set of energy properties associated with the design layout includes a set of thermal properties associated with the design layout.

3. The computer-implemented method of clauses 1 or 2, wherein the design layout comprises a set of tiles, each tile included in the set of tiles having embedded metadata specifying at least one energy property associated with the tile.

4. The computer-implemented method of any of clauses 1-3, wherein a first tile included in the set of tiles of the design layout includes a first geometric element representing a first surface type, wherein a first energy property of the first tile is determined based on the first surface type.

5. The computer-implemented method of any of clauses 1-4, wherein a first tile included in the set of tiles of the design layout includes a first geometric element representing a first surface type, wherein the first surface type comprises at least one of a door, a window, a wall, a floor, or a roof.

6. The computer-implemented method of any of clauses 1-5, wherein the design layout comprises a set of tiles and the embedded metadata of the design layout is stored to a data structure associated with the design layout that organizes the embedded metadata based on the set of tiles of the design layout.

7. The computer-implemented method of any of clauses 1-6, wherein generating the energy model for the design layout includes automatically extracting the embedded metadata from the design layout and labeling the energy model with the embedded metadata.

8. The computer-implemented method of any of clauses 1-7, wherein the design layout comprises a plurality of tiles, each tile in the plurality of tiles being associated with at least one energy property, the energy model comprises a plurality of sub-portions, each sub-portion corresponding to a particular tile in the design layout, and generating the energy model for the design layout includes automatically labeling each sub-portion of the energy model with the at least one energy property associated with a corresponding tile in the design layout.

9. The computer-implemented method of any of clauses 1-8, wherein the energy-analysis simulation is executed on the energy model by an energy-analysis solver, wherein the energy model comprises Building Energy Model (BEM) geometry in a format compatible with the energy-analysis solver.

10. The computer-implemented method of any of clauses 1-9, wherein the set of simulation results include at least one of an energy performance metric or a comfort performance metric.

11. In some embodiments, one or more non-transitory computer-readable media include instructions that, when executed by one or more processors, cause the one or more processors to perform an energy-analysis simulation by performing the steps of generating a design layout of a building, the design layout including embedded metadata specifying a set of energy properties associated with the design layout, generating an energy model for the design layout based on the embedded metadata of the design layout, executing the energy-analysis simulation on the energy model to generate a set of simulation results, and displaying the set of simulation results.

12. The one or more non-transitory computer-readable media of clause 11, wherein the set of energy properties associated with the design layout includes a set of thermal properties associated with the design layout.

13. The one or more non-transitory computer-readable media of clauses 11 or 12, wherein the design layout comprises a set of tiles, each tile included in the set of tiles having embedded metadata specifying at least one energy property associated with the tile.

14. The one or more non-transitory computer-readable media of any of clauses 11-13, wherein the design layout comprises a set of tiles, wherein a first tile in the set of tiles includes a first geometric element representing a first surface type and having a first construction type.

15. The one or more non-transitory computer-readable media of any of clauses 11-14, wherein a first energy property of the first tile is determined based on the first surface type and the first construction type.

16. The one or more non-transitory computer-readable media of any of clauses 11-15, wherein the first surface type comprises at least one of an interior wall, an air wall, a ceiling, an exterior floor, an interior floor, an outdoor shade, or an indoor shade.

17. The one or more non-transitory computer-readable media of any of clauses 11-16, wherein generating the energy model for the design layout includes automatically extracting the embedded metadata from the design layout and labeling the energy model with the embedded metadata.

18. The one or more non-transitory computer-readable media of any of clauses 11-17, wherein the design layout comprises a plurality of tiles, each tile in the plurality of tiles being associated with at least one energy property, the energy model comprises a plurality of sub-portions, each sub-portion corresponding to a particular tile in the design layout, and generating the energy model for the design layout includes automatically labeling each sub-portion of the energy model with the at least one energy property associated with a corresponding tile in the design layout.

19. The one or more non-transitory computer-readable media of any of clauses 11-18, wherein the energy-analysis simulation is executed on the energy model by an energy-analysis solver, wherein the energy model comprises Building Energy Model (BEM) geometry in a format compatible with the energy-analysis solver.

20. In some embodiments, a computer system comprises a memory that includes instructions, and at least one processor that is coupled to the memory and, upon executing the instructions, perform an energy-analysis simulation by performing the steps of generating a design layout of a building, the design layout including embedded metadata specifying a set of energy properties associated with the design layout, generating an energy model for the design layout based on the embedded metadata of the design layout, executing the energy-analysis simulation on the energy model to generate a set of simulation results, and displaying the set of simulation results.

Any and all combinations of any of the claim elements recited in any of the claims and/or any elements described in this application, in any fashion, fall within the contemplated scope of the present embodiments and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon. The software constructs and entities (e.g., engines, modules, GUls, etc.) are, in various embodiments, stored in the memory/memories shown in the relevant system figure(s) and executed by the processor(s) shown in those same system figures.

Any combination of one or more computer readable medium(s) can be utilized. The computer readable medium can be a computer readable signal medium or a computer readable storage medium. A computer readable storage medium can be, for example, but not limited to, an electronic, non-transitory, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for performing an energy-analysis simulation, the method comprising:
generating a design layout of a building, the design layout including embedded metadata specifying a set of energy properties associated with the design layout;
generating an energy model for the design layout based on the embedded metadata of the design layout;
executing the energy-analysis simulation on the energy model to generate a set of simulation results; and
displaying the set of simulation results.

2. The computer-implemented method of claim 1, wherein the set of energy properties associated with the design layout includes a set of thermal properties associated with the design layout.

3. The computer-implemented method of claim 1, wherein the design layout comprises a set of tiles, each tile included in the set of tiles having embedded metadata specifying at least one energy property associated with the tile.

4. The computer-implemented method of claim 3, wherein a first tile included in the set of tiles of the design layout includes a first geometric element representing a first surface type, wherein a first energy property of the first tile is determined based on the first surface type.

5. The computer-implemented method of claim 3, wherein a first tile included in the set of tiles of the design layout includes a first geometric element representing a first surface type, wherein the first surface type comprises at least one of a door, a window, a wall, a floor, or a roof.

6. The computer-implemented method of claim 1, wherein the design layout comprises a set of tiles and the embedded metadata of the design layout is stored to a data structure associated with the design layout that organizes the embedded metadata based on the set of tiles of the design layout.

7. The computer-implemented method of claim 1, wherein generating the energy model for the design layout includes automatically extracting the embedded metadata from the design layout and labeling the energy model with the embedded metadata.

8. The computer-implemented method of claim 1, wherein:
the design layout comprises a plurality of tiles, each tile in the plurality of tiles being associated with at least one energy property;
the energy model comprises a plurality of sub-portions, each sub-portion corresponding to a particular tile in the design layout; and
generating the energy model for the design layout includes automatically labeling each sub-portion of the energy model with the at least one energy property associated with a corresponding tile in the design layout.

9. The computer-implemented method of claim 1, wherein the energy-analysis simulation is executed on the energy model by an energy-analysis solver, wherein the energy model comprises Building Energy Model (BEM) geometry in a format compatible with the energy-analysis solver.

10. The computer-implemented method of claim 1, wherein the set of simulation results include at least one of an energy performance metric or a comfort performance metric.

11. One or more non-transitory computer-readable media including instructions that, when executed by one or more processors, cause the one or more processors to perform an energy-analysis simulation by performing the steps of:
generating a design layout of a building, the design layout including embedded metadata specifying a set of energy properties associated with the design layout;
generating an energy model for the design layout based on the embedded metadata of the design layout;
executing the energy-analysis simulation on the energy model to generate a set of simulation results; and
displaying the set of simulation results.

12. The one or more non-transitory computer-readable media of claim 11, wherein the set of energy properties associated with the design layout includes a set of thermal properties associated with the design layout.

13. The one or more non-transitory computer-readable media of claim 11, wherein the design layout comprises a set of tiles, each tile included in the set of tiles having embedded metadata specifying at least one energy property associated with the tile.

14. The one or more non-transitory computer-readable media of claim 11, wherein the design layout comprises a set of tiles, wherein a first tile in the set of tiles includes a first geometric element representing a first surface type and having a first construction type.

15. The one or more non-transitory computer-readable media of claim 14, wherein a first energy property of the first tile is determined based on the first surface type and the first construction type.

16. The one or more non-transitory computer-readable media of claim 14, wherein the first surface type comprises at least one of an interior wall, an air wall, a ceiling, an exterior floor, an interior floor, an outdoor shade, or an indoor shade.

17. The one or more non-transitory computer-readable media of claim 11, wherein generating the energy model for the design layout includes automatically extracting the embedded metadata from the design layout and labeling the energy model with the embedded metadata.

18. The one or more non-transitory computer-readable media of claim 11, wherein:
the design layout comprises a plurality of tiles, each tile in the plurality of tiles being associated with at least one energy property;
the energy model comprises a plurality of sub-portions, each sub-portion corresponding to a particular tile in the design layout; and
generating the energy model for the design layout includes automatically labeling each sub-portion of the energy model with the at least one energy property associated with a corresponding tile in the design layout.

19. The one or more non-transitory computer-readable media of claim 11, wherein the energy-analysis simulation is executed on the energy model by an energy-analysis solver, wherein the energy model comprises Building Energy Model (BEM) geometry in a format compatible with the energy-analysis solver.

20. A computer system comprising:
a memory that includes instructions; and
at least one processor that is coupled to the memory and, upon executing the instructions, perform an energy-analysis simulation by performing the steps of:
generating a design layout of a building, the design layout including embedded metadata specifying a set of energy properties associated with the design layout;
generating an energy model for the design layout based on the embedded metadata of the design layout;
executing the energy-analysis simulation on the energy model to generate a set of simulation results; and
displaying the set of simulation results.
